(19) United States
(12) Patent Application Publication
(10) Pub. No.: US 2014/0365395 A1
(43) Pub. Date: Dec. 11, 2014

(54) ELECTRONIC BUSINESS CARD APPLICATION SOFTWARE AND ITS SYSTEM

(71) Applicant: Onekarte, Inc., San Francisco, CA (US)

(72) Inventors: Alan ARGUELLES, Daly City, CA (US); Junji Suzuki, San Francisco, CA (US); Masamichi Yamasaki, San Leandro, CA (US); Yojiro Kamei, San Jose, CA (US)

(21) Appl. No.: 13/913,424

(22) Filed: Jun. 8, 2013

(51) Int. Cl. G06Q 10/10

(52) U.S. Cl. CPC G06Q 10/10
USPC 705/342

(57) ABSTRACT

Present invention enables to easily exchange the electronic business cards, using smart phones or other type of handheld computers. First, the user sets up an electronic business card in his/her smart phone. This electronic business card is exchanged with other users through the smart phones. Thereby, the user can obtain other users' electronic business cards. The user can also scan a paper business card. The user can organize these received and scanned electronic business cards in his/her smart phone. The data related to the user's and other people's electronic business cards is backed up in a server. Furthermore, various useful functions can be called through the stored electronic business cards. Useful information related to the stored electronic business cards is also provided.

### TECHNICAL FIELD

The present invention relates to an electronic business card application software and the system including the electronic business card application software.

### BACKGROUND OF THE INVENTION

Business cards are essential business items for most businessmen. Not only that, but many people also use their private business cards as a tool for their social communication. The history of business card is quite old and it is known that the business cards were already used in 17th century in Europe and 15th century in China. Traditionally and even now, most business cards are a paper form.

Since the business cards contain useful information such as company name, title and contact information, many business people utilize them for their daily business activities. Because the business cards are so popular in the business scene that many business people end up to accumulate a huge number of business cards. As a result, it becomes difficult to find the business card the business person needs now. In addition, such business cards often become necessary outside of the office, where access to the stored business cards is very limited. Furthermore, business cards easily become obsolete, and the information printed on the business card may not be the latest one about that person.

### SUMMARY OF THE INVENTION

The inventors came up with an idea to convert the paper business card into electronic form. Nowadays, almost everyone has a cellular phone. People usually carry their cellular phones when they go out. Therefore, the inventors thought the cellular phone is an ideal medium to carry and exchange the electronic business cards. Latest cellular phone is often called ‘smart phone’ because it can run various application software on it. In addition to the cellular phone, other portable electronic devices such as tablets are also becoming popular and can communicate with other electronic devices. The inventors have developed an electronic business card application software utilizing the abilities of such communicable portable electronic devices. Now, the users can exchange the electronic business cards just by letting the two portable electronic devices close to each other and letting them communicate to each other.

In this application software, in the beginning, the user sets up user's own electronic business card in his/her portable electronic device. This electronic business card is exchanged with other users through the portable electronic devices. Thereby, the user can obtain other person's electronic business card and store it in his/her portable electronic device. The user can also scan a paper business card and store it as a digital form. The user can organize these received and scanned electronic business cards in his/her portable electronic device without distinguishing the origin of the business card. The data related to the user's and other people's electronic business cards is backed up in a server. The application software can retrieve updated information of other people's electronic business cards from a database so that the user can have the latest information about other users. Furthermore, various useful functions can be called through these stored electronic business cards. Useful information related to the stored electronic business cards can also be provided to the user by the electronic business card application software.

### BRIEF DESCRIPTION OF THE DRAWINGS

FIG. 1 is mainly used in §1.

FIG. 1 is a schematic diagram showing an embodiment of the electronic business card system.

FIGS. 2-11 are mainly used in §2.

FIG. 2 is a display image of an embodiment of an electronic business card application software wherein the application software is starting on a cellular phone.

FIG. 3 is a display image of the application software when the application software has started up in the first time.

FIG. 4 is a display image of the application software after ‘Sign Up’ shown in FIG. 3 is selected.

FIG. 5 is a display image of the application software after the user has signed up but has not created his/her electronic business card yet.

FIG. 6 is a display image of the application software when basic information for the electronic business card is being inputted.

FIG. 7 is a display image of the application software while the template of the electronic business card is being selected.

FIG. 8 is a portion of display image of the application software after a logo shown in FIG. 7 is selected.

FIG. 9 is a flowchart showing a process to allow only the selected users to use a specific card layout, which includes a specific logo.

FIG. 10 is a display image of the application software while asking the user to input a passcode.

FIG. 11 is a display image of the application software after an icon ‘Sign In’ shown in FIG. 3 is selected.

FIGS. 12-33 are mainly used in §3.

FIG. 12 is a display image of the electronic business card application software wherein a default image immediately after signing in is displayed.

FIG. 13 is a display image of the application software when the cellular phone is turned in a landscape orientation.

FIG. 14 is a display image of the application software after categories shown in FIG. 12 are slid down.

FIG. 15 is a flowchart showing a process of changing the electronic business card based on the location.

FIG. 16 is a display image of the application software while asking the permission to change the default electronic business card after the application software has detected a specific location.

FIG. 17 is a flowchart showing a process of automatically changing the electronic business card based on the location.

FIG. 18 is a display image of the application software after one category shown in FIG. 12 is swiped from left to right.

FIG. 19 is a portion of display image of the application software after a Delete icon shown in FIG. 18 is selected.

FIG. 20 is a display image of the electronic business card application software after one category is opened.

FIG. 21 is a display image of the application software while the category name shown in FIG. 20 is being renamed.

FIG. 22 is a display image of the application software after one electronic business card shown in FIG. 20 is virtually flipped. This is the other side of the electronic business card. When the user taps on the logo at the center, the user can change the logo of the business card.

FIG. 23 is a display image of the application software after an ‘Add’ icon shown in FIG. 22 is tapped. The user can type words to help remember the contact better.

FIG. 24 is a display image of the application software after one electronic business card shown in FIG. 20 is swiped from left to right to show additional options the user has for this card.

FIG. 25 is a portion of display image of the application software after a ‘Move’ icon shown in FIG. 24 is selected. To ‘Move’ means to transfer an electronic business card from one category to another.

FIG. 26 is a display image of the application software after a ‘Notes’ icon shown in FIG. 24 is selected.

FIG. 27 is a portion of display image of the application software after ‘Delete’ icon shown in FIG. 24 is selected.

FIG. 28 is portions of display images of the application software after an e-mail address, a telephone number, or an address shown in one of the electronic business cards in FIG. 20 is selected.

FIG. 29 is a display image of the application software after a ‘Navigate’ icon shown in FIG. 28C is selected.

FIG. 30 is a flowchart showing a process by which a Scout function of the application software is performed. 1. Obtain current user location. 2. Send the current user location to the server. 3. Send notification to the other person being located (i.e. “Joe Kamei would like to know your current location. Would you like to broadcast your location to him?” Y/N). 4. Permission/Response sent to the server. 5. The other person broadcasts the other person's current location. 6. The user receives the other person's location. 7. The user uses Map services on the phone.

FIG. 31 is a display image of the application software when a category ‘Trash’ is opened.

FIG. 32 is a display image of the application software after one electronic business card shown in FIG. 31 is swiped from left to right and a ‘Restore’ icon is selected.

FIG. 33 is a portion of display image of the application software after an ‘empty’ icon shown in FIG. 31 is selected.

FIGS. 34-57 are mainly used in §4.

FIG. 34 is a portion of display image of the electronic business card application software after a menu icon shown in FIG. 12 or 20 is selected.

FIG. 35 is a display image of the application software after a Search icon shown in FIG. 34 is selected.

FIG. 36 is a display image of the application software after a Setting icon shown in FIG. 34 is selected.

FIG. 37 is a display image of the application software after a Card Exchange icon shown in FIG. 34 is selected.

FIG. 38 is a display image of the application software after a ‘Receive Only’ icon shown in FIG. 37 is selected.

FIG. 39 is a display image of the application software after a Send Card icon that can be appeared after swiping one of the electronic business card shown in FIG. 20 is selected.

FIG. 40 is a schematic view showing an embodiment in which two cellular phones are exchanging the electronic business cards.

FIG. 41 is a display image of the application software while the two cellular phones are exchanging the electronic business cards.

FIG. 42 is a display image of the application software after receiving the other person's electronic business card.

FIG. 43 is a display image of the application software after an ‘ADD NEW STACK’ icon shown in FIG. 42 is selected.

FIG. 44 is a display image of the application software after a Card Scan icon shown in FIG. 34 is selected.

FIG. 45 is a display image of the application software after an image of the paper business card is captured.

FIG. 46 is a portion of display image of the application software after the scanned front side of the paper business card is confirmed.

FIG. 47 is a display image of the application software after finishing taking the picture of the paper business card.

FIG. 48 is a display image of the application software while the displayed information shown in FIG. 47 is being edited.

FIG. 49 is a display image of the application software after the information edit is done.

FIG. 50 is a display image of the application software after the electronic business card shown in FIG. 49 is categorized.

FIG. 51 is a flowchart showing a process of automatically sending a text message to a person whose telephone number is indicated in the scanned paper business card.

FIG. 52 is a flowchart showing a process of scanning plural paper business cards as a batch process.

FIG. 53 is a display image of the application software after the images of plural paper business cards are captured.

FIG. 54 is a flowchart showing a process by which a Scout-All function of the application software is performed. 1. Find people in user's contacts that are near the user. 2. Display the names and distances of the people near the user. 3. Send Notification to all, requesting location. 4. If permission is granted, their locations are revealed in the map.

FIG. 55 is a display image of the application software after a Scout-All icon shown in FIG. 34 is selected. This figure shows how far the contacts are from the user.

FIG. 56 is a display image of the application software after one person shown in FIG. 55 is selected.

FIG. 57 is a display image of the application software after a Scout-All icon shown in FIG. 55 or 56 is selected.

FIGS. 58-60 are mainly used in §5.

FIG. 58 is a display image of a computer screen when a template of the electronic business card is being changed by using a computer shown in FIG. 1.

FIG. 59 is a display image of the electronic business card application software after the software detects that at least one of the other people's electronic business cards is updated.

FIG. 60 is a flowchart showing a process by which the application software is synchronizing its data with the one in the server shown in FIG. 1.

### DETAILED DESCRIPTION OF THE INVENTION

Embodiments of the present invention are described with the accompanying drawings. The ensuing description is not intended to limit the scope of the invention. Rather, preferred exemplary embodiments are provided for those skilled in the art to enable to implement the invention. It is noted that the present invention may be embodied in different forms without departing from the spirit and scope of the invention as set forth in the appended claims.

### §1. Overview of the Electronic Business Card System

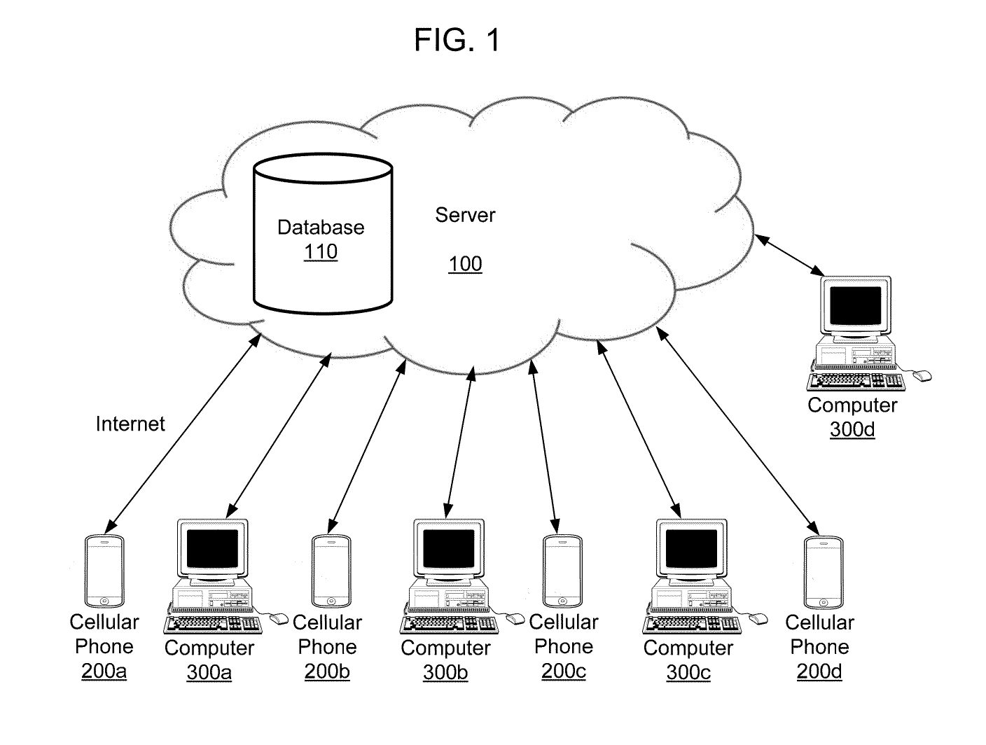

FIG. 1 shows a schematic overview of the electronic business card application software system. As shown in this figure, this system employs a cloud based architecture, and this system is composed of a server 100, cellular phones 200a-200d and computers 300a-300d. The server 100 has a database 110. The electronic business card application software is installed in the cellular phones 200a-200d, and it configures the cellular phones 200a-200d to communicate with the server 100 through the Internet. Also, the computers 300a-300d can access to the server 100 through the Internet.

Although FIG. 1 depicts cellular phones 200a-200d as a representative of portable electronic devices, other embodiment can include other portable electronic devices such as tablet. In other embodiment, computers 300a-300c or other electronic device, even if not portable, may run the electronic business card application software.

Below, the electronic business card application software that is run in the cellular phones 200a-200d is explained in detail. The roles of the server 100 are explained as specific aspects of the electronic business card application software are explained.

### §2. Setup of the Electronic Business Card

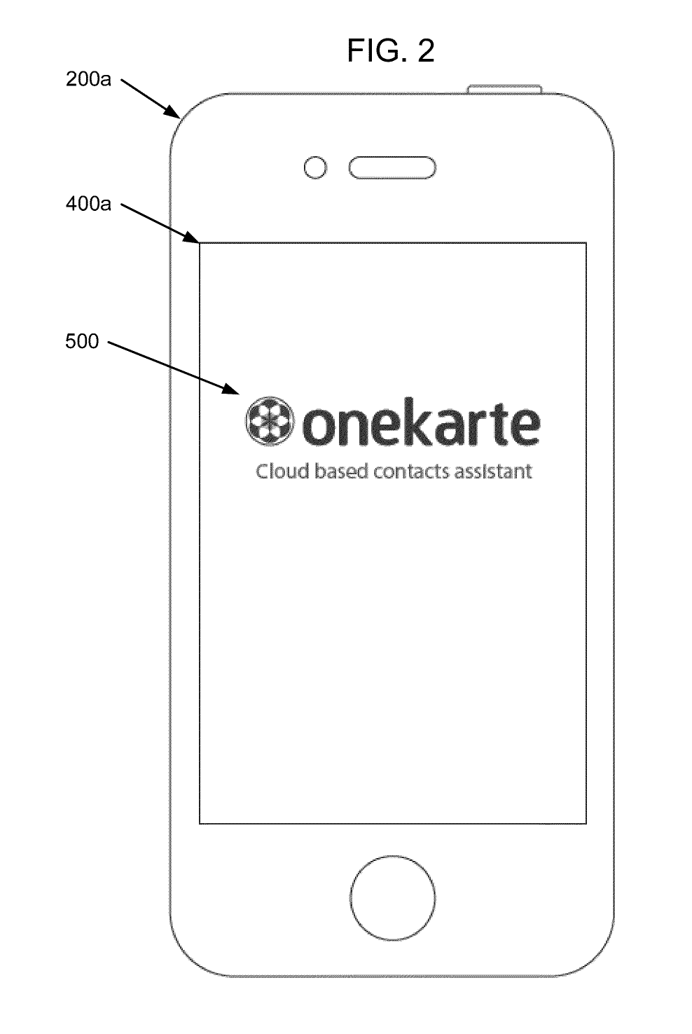

This section is explained with FIGS. 2-11 with the order shown in Table 1.

### [Table 1]

To run the electronic business card application software, the user needs to download the application software from the server 100 to the cellular phone 200a. FIG. 2 is a display image while the electronic business card application software is starting up. As shown in this figure, a product logo 500 is displayed on the touch panel screen 400a of the cellular phone 200a while it is starting up.

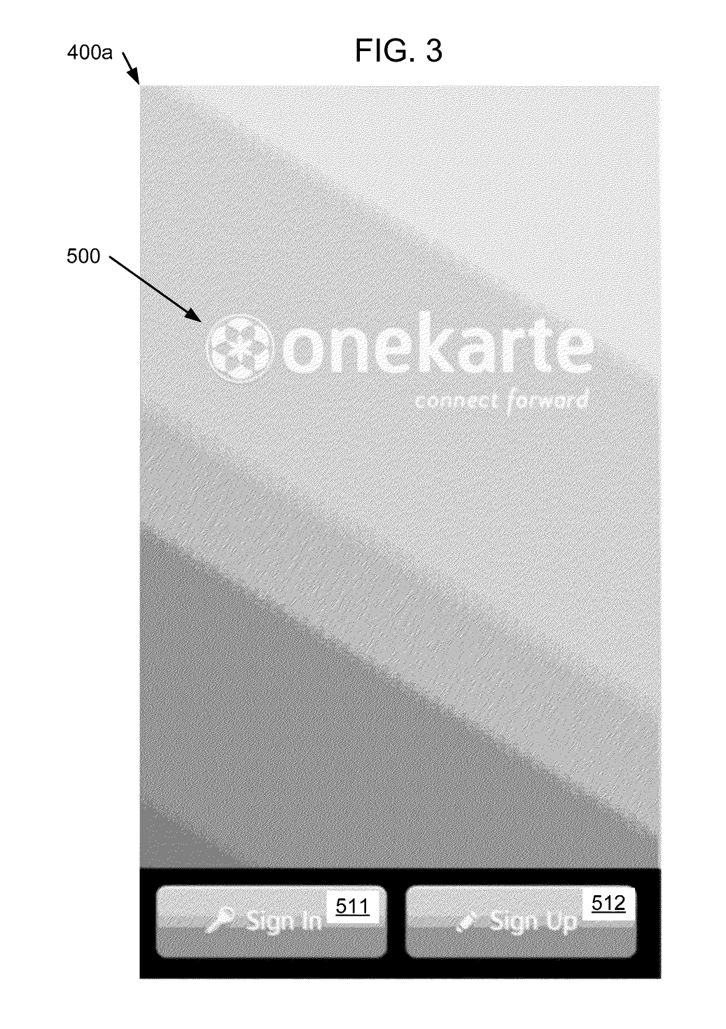

As shown in FIG. 3, once the software has started up, two icons, ‘Sign In’ icon 511 and ‘Sign Up’ icon 512 are displayed on the screen 400a.

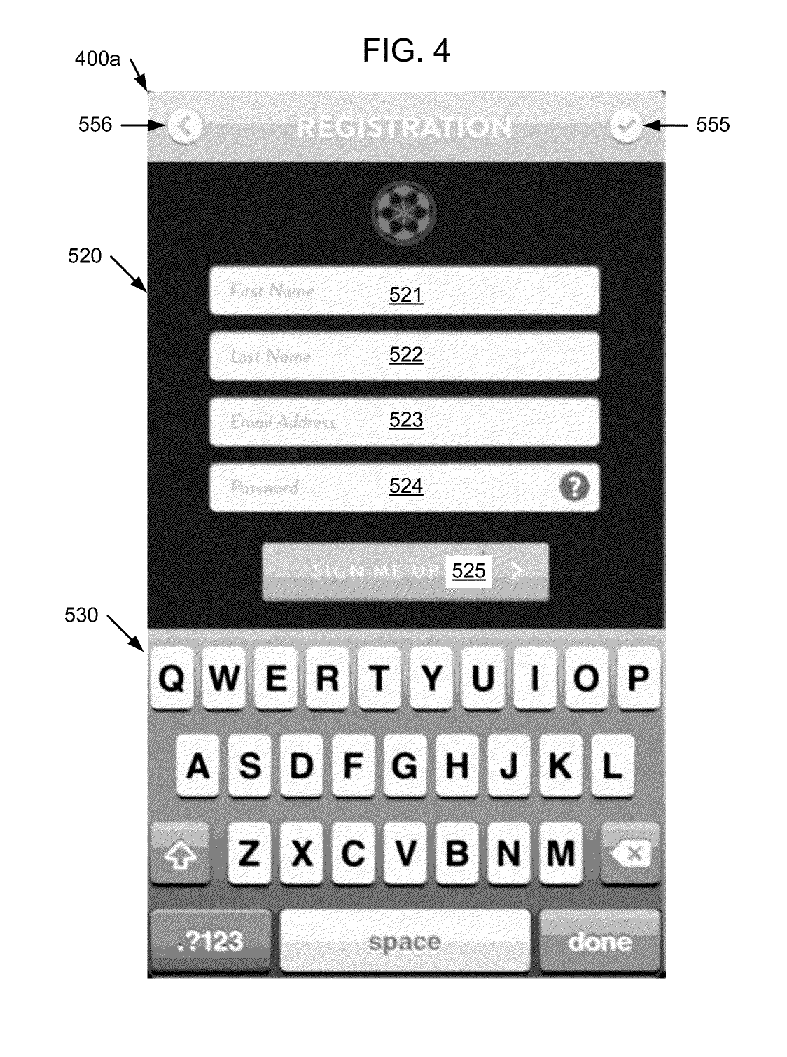

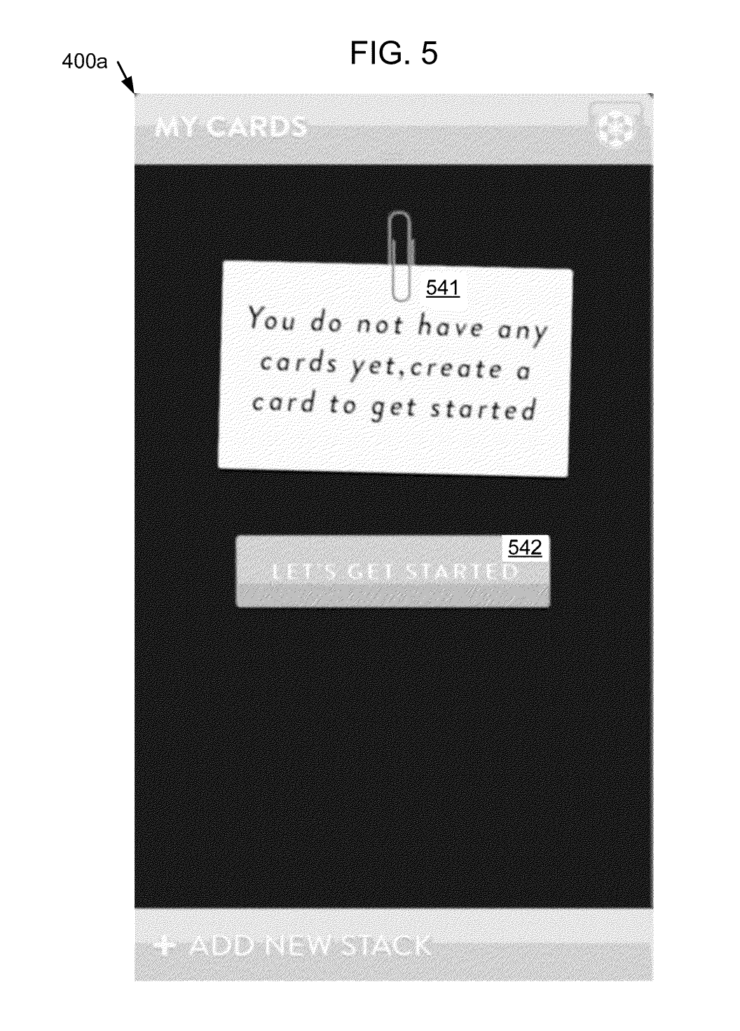

Once the user taps the ‘Sign Up’ icon 512 on the screen with a finger (or also called click) and selects the ‘Sign Up’ button, the display image turns like FIG. 4, and the user can register his/her basic information. As shown in this figure, a ‘REGISTRATION’ form 520 is displayed in the upper part, and an on-screen keyboard 530 is displayed in the lower part of the screen 400a. The ‘REGISTRATION’ form 520 contains a ‘First Name’ field 521, a ‘Last Name’ field 522, an ‘E-mail address’ field 523 and a ‘Password’ field 524 from top to bottom. By tapping one of the fields 521-524, a cursor is displayed on this field, and the user can input necessary information by tapping the on-screen keyboard 530. Once the user finishes typing the necessary information, a ‘Sign-Me-Up’ icon 525 or a proceed icon 555 is tapped. Then, the display image turns like FIG. 5. By tapping the back icon 556, the user can go back to the display image as shown in FIG. 3.

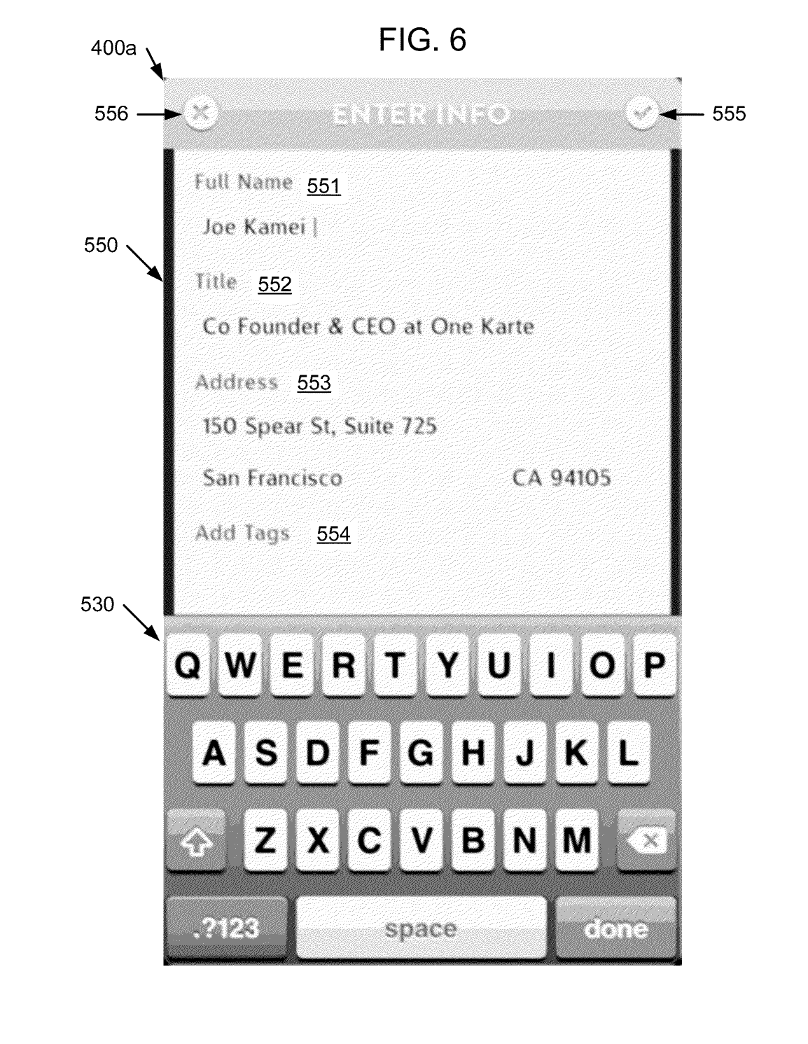

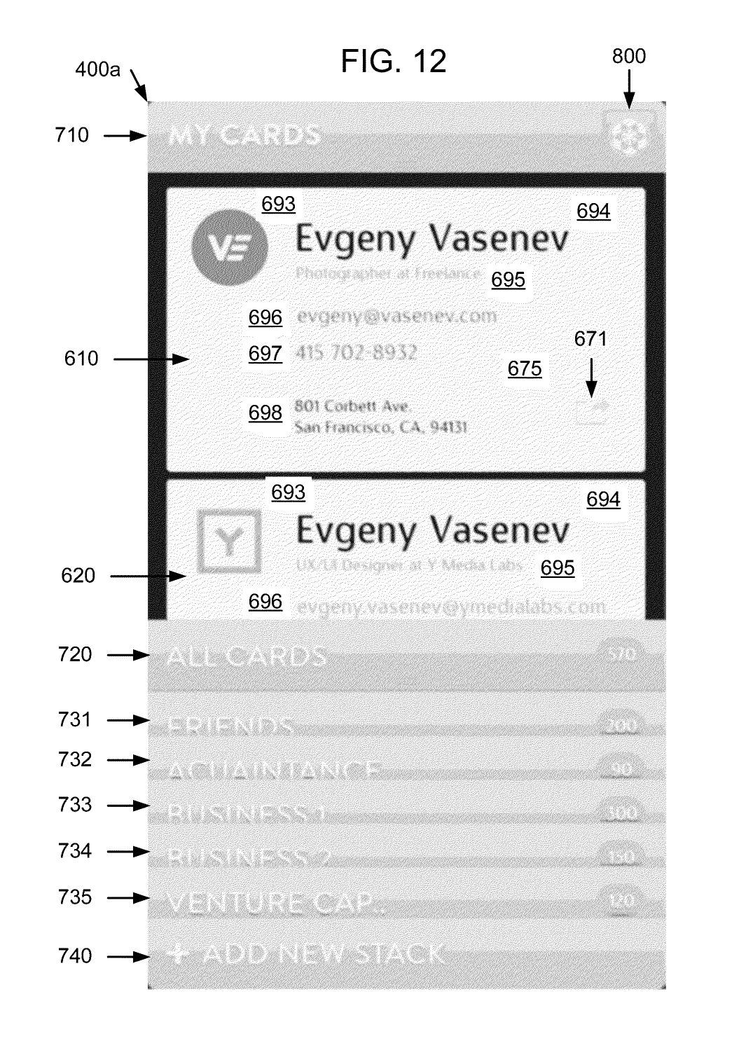

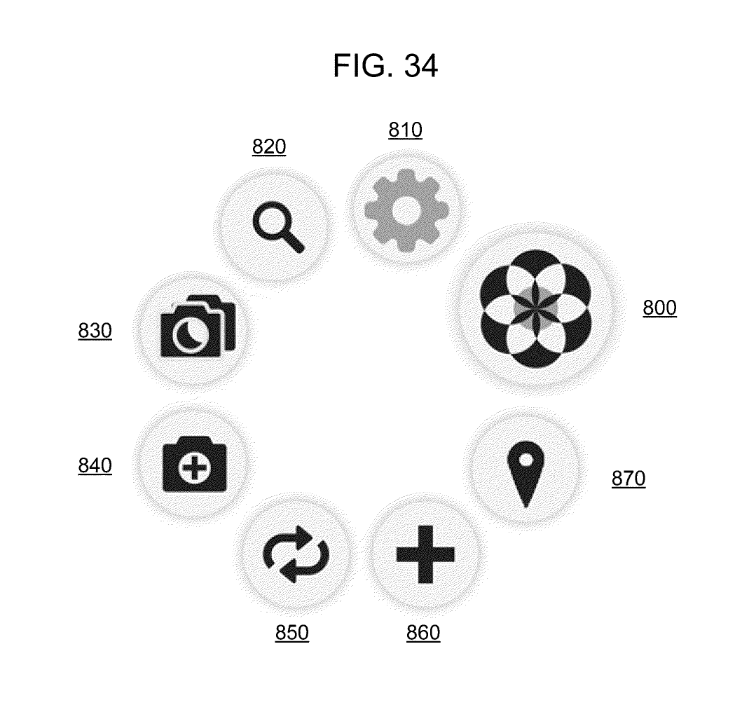

After the registration, as shown in FIG. 5, a message 541 appears on the screen 400a. This message 541 indicates that there is no electronic business card available to the user yet. Thus, message 541 also prompts the user to create an electronic business card. Once the user taps a “LET'S GET STARTED” icon 542, the display image turns like FIG. 6. The user can also scan his/her personal paper business card to create his/her first electronic business card. This is achieved by tapping a Menu icon 800 in FIG. 12. This leads additional options to appear as shown in FIG. 34. By tapping a Scan icon 840, the user can scan his/her paper business card.

FIG. 6 is a display image while the software is letting the user input basic information that is associated with the user's electronic business card. As shown in this figure, an ‘ENTER INFO’ form 550 is displayed in the upper part of the screen 400a. The ‘ENTER INFO’ form 550 contains a ‘Full Name’ field 551, a ‘Title’ field 552, an ‘Address’ field 553 and an ‘Add Tags’ field 554 from top to bottom. By tapping one of the fields 551-553, a cursor is displayed on this field, and the user can input necessary information by tapping the on-screen keyboard 530. Although not shown in FIG. 6, the user can also input e-mail address, business phone number, fax number and cellular phone number. Such information is displayed in the user's electronic business card once it is created. The function ‘Add Tags’ is explained later. Once the user finishes typing the necessary information, the user taps the proceed icon 555. If the user does not like it, he/she can discard the typed information by tapping the discard icon 556.

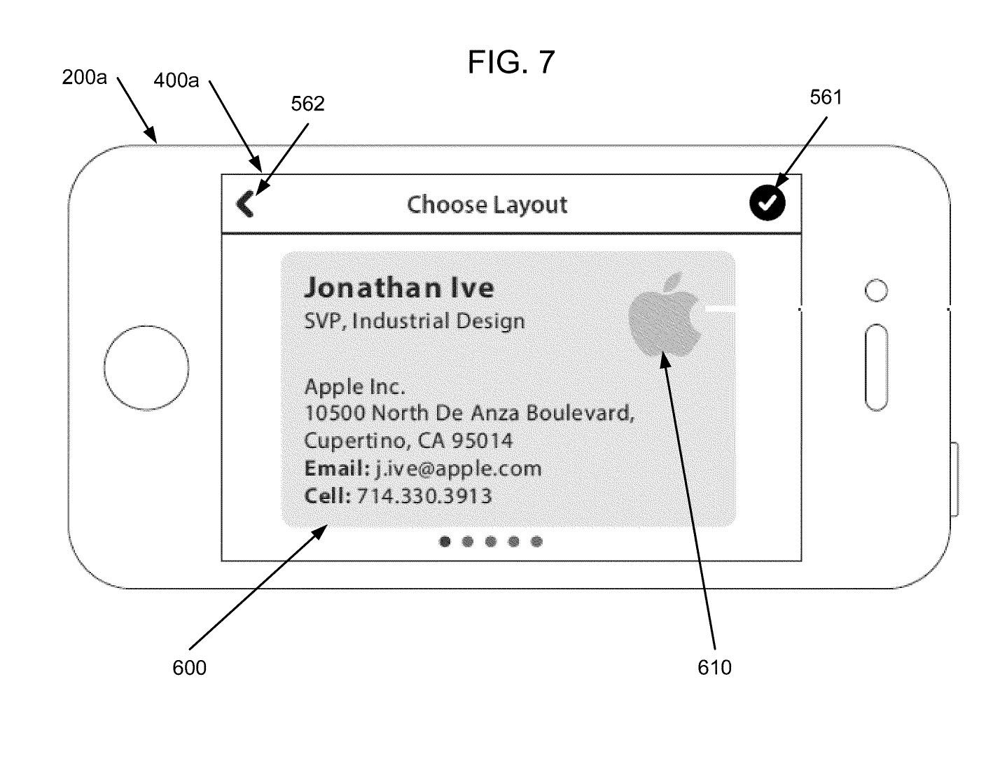

Once the user taps the proceed icon 555, the display image turns like FIG. 7. There, the user can choose the template (or ‘Layout’ in the figure) of the electronic business card he/she is going to use. If the user swipes the electronic business card 600 from left to right or right to left, in short in a landscape direction, the electronic business card 600 is displayed with a layout of next template. Thereby, the user can choose his/her favorite template.

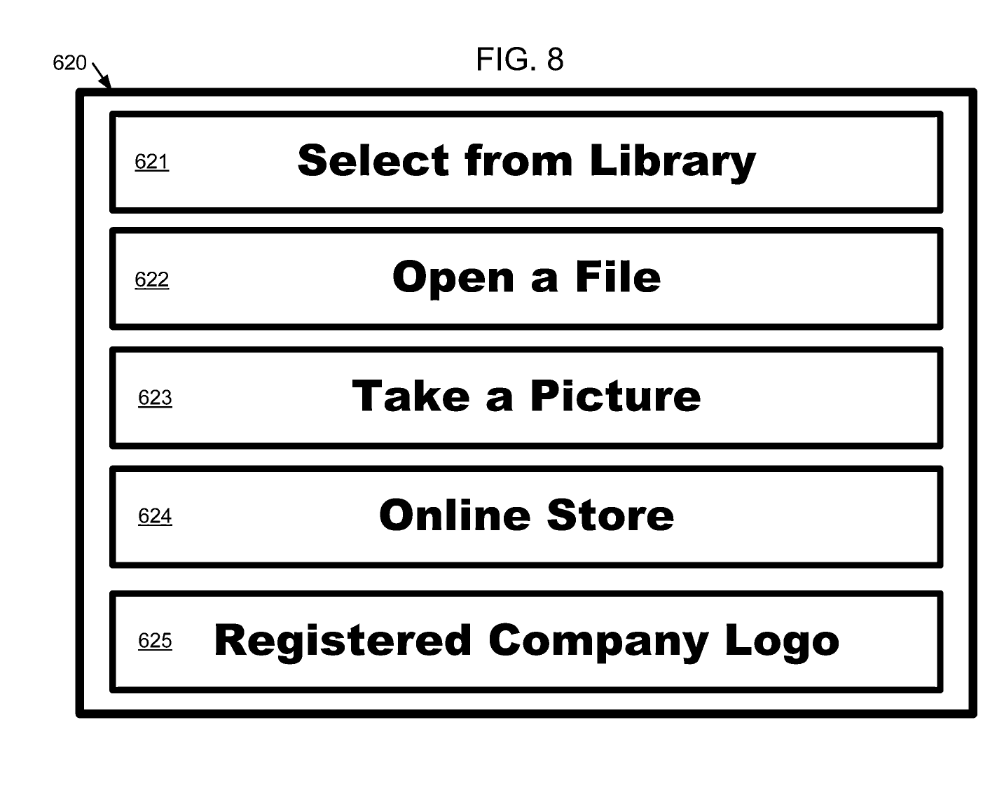

A logo 610 is displayed in the upper right portion of the electronic business card 610. Once the user taps the logo 610, a menu 620 shown in FIG. 8 is displayed in the center of the screen 400a. The menu 620 contains menu items 621-625. When the menu item 621 is tapped, the user can select the logo 610 from the logos provided in the electronic business card application software as a default. When the menu item 622 is tapped, the user can set an image file such as jpg, gif, tiff or png file stored in the cellular phone 200a as the logo 610. When the menu item 623 is tapped, the user can take a picture, using a camera function of the cellular phone 200a, and use the taken picture as the logo 610. When the menu item 624 is tapped, the cellular phone 200a connects to the server 100 (please refer FIG. 1) through the Internet and the user can purchase a logo from various lineups. Then, the user can use the purchased logo as the logo 610.

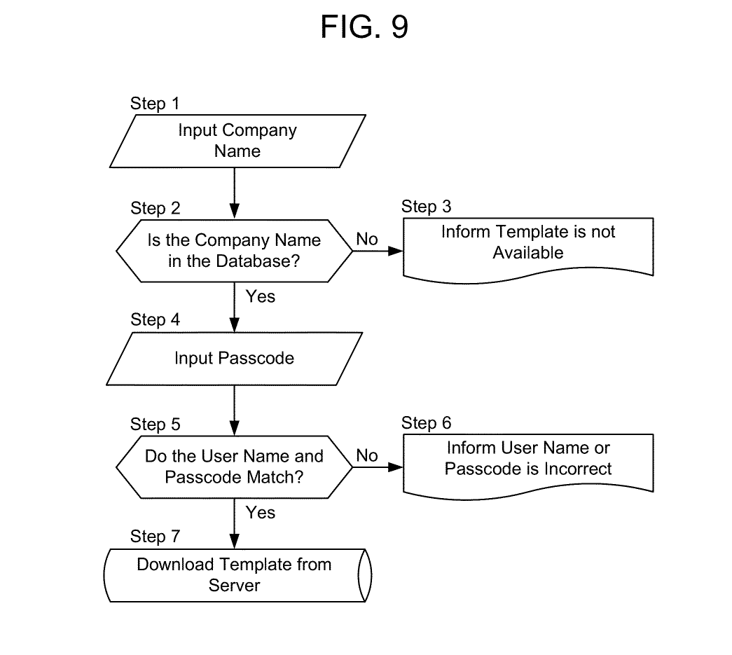

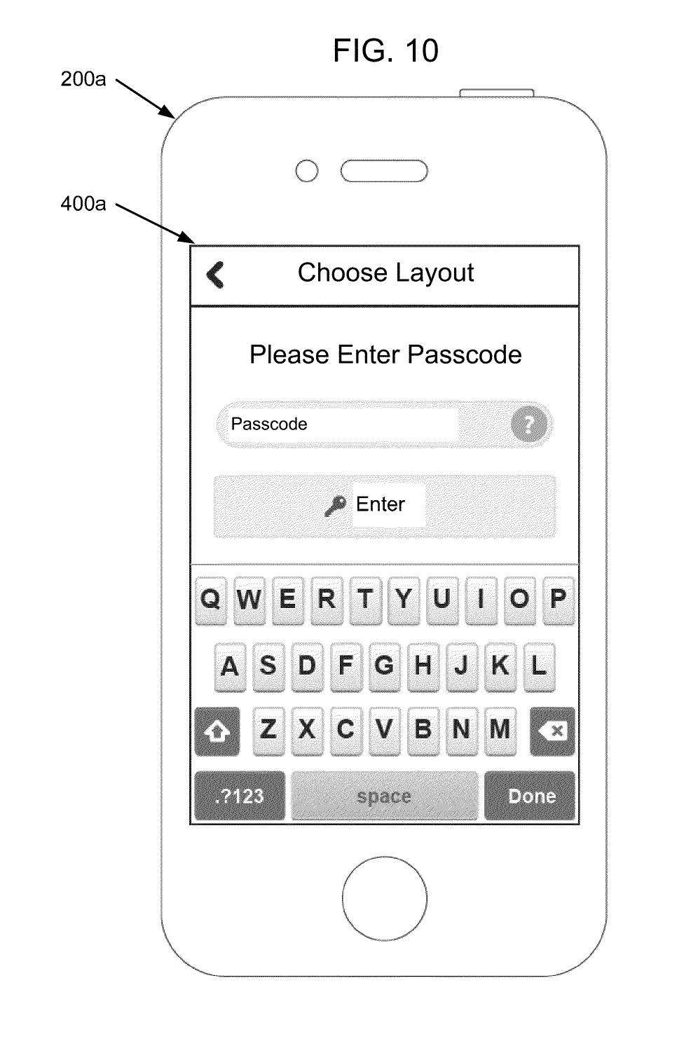

The menu item 625 is special. The only selected users can use the templates provided though this menu item 625. Once the user taps the menu item 625, as shown in FIG. 9, the electronic business card application software prompts the user to type a company name (Step 1). After the user finishes the input, the cellular phone 200a connects to the server 100 (please refer FIG. 1) through the Internet. The database 110 of the server 100 stores company names and templates for these companies. Through this database 110, the electronic business card application software determines if the typed company name and template exist in the database 110 (Step 2). If there is no company name or its template, the software displays a message informing that there is no template available for this company (Step 3). If there is the matched company name and its template, as shown in FIG. 10, the electronic business card application software prompts the user to input a passcode (Step 4). Next, the electronic business card application software determines if the name of the user exists in a list stored in the database 110 and the passcode matches in the list (Step 5). This list is provided from a company that owns a specific template including company logo. The company can register the template, image data of the logo, list of the names of the people who are allowed to use the template and the passcodes for each person for example through the computer 300d to the server 100 (please refer FIG. 1). Then, only the person whose name is in the list and who correctly typed the passcode assigned from the company is allowed to use the business card template that contains the company logo. In other embodiment, the list may include other user information such as cellular phone number and e-mail address, and the electronic business card application software may compare such information registered in the electronic business card application software with the information in the list. Going back to FIG. 9, if the name of the user does not exist in the list provided from the company or the passcode typed by the user does not match the one in the list, the software displays a message informing that the user name or the passcode may be wrong (Step 6). If the name of the user exists in the list and the passcode typed by the user matches the one in the list, the software downloads the company's business card template from the server 100, allowing the user to use it in their electronic business card (Step 7). In other embodiment, the software may download just the company's logo, allowing the user to select the template from regular lineups.

Going back to FIG. 7, once the user has chosen the template, he/she taps a finish icon 561. Then the user's own electronic business card is created and stored in the cellular phone 200a. When the user wants to edit the information displayed in the electronic business card, he/she can tap a back icon 562. Then, the screen 400a goes back to FIG. 6.

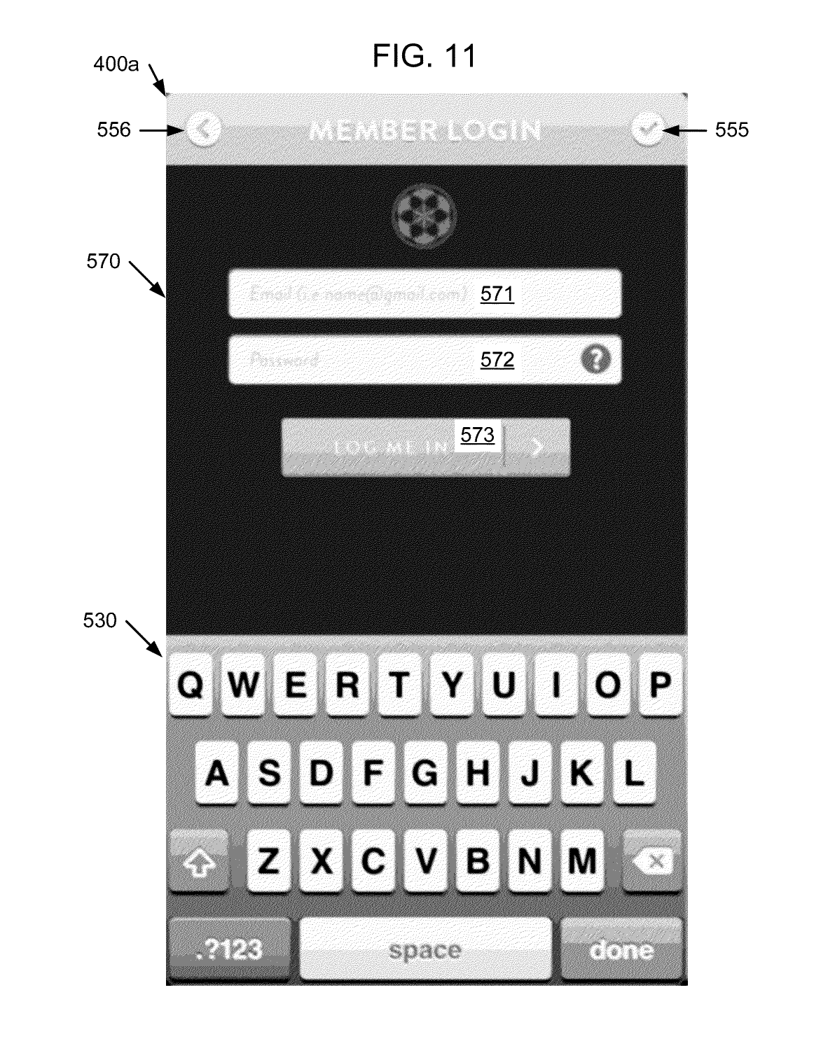

Going back to FIG. 3, when the user taps the ‘Sign In’ icon 511 after the electronic business card application software has started up, the display image turns like FIG. 11. As shown in this figure, a ‘MEMBER LOGIN’ form 570 is displayed in the upper part of the screen 400a. The ‘MEMBER LOGIN’ form 570 contains an ‘E-mail Address’ field 571 and a ‘Password’ field 572 from top to bottom. By tapping one of the fields 571-572, a cursor is displayed on this field, and the user can input necessary information by tapping the on-screen keyboard 530. Once the user finishes typing the necessary information, the user taps a ‘LOG ME IN’ icon 573 or the proceed icon 555. Then, the electronic business card application software access to the server 100 through the Internet (please refer FIG. 1), and download all the data to restore the software configuration and the information (including electronic business cards) the user has collected until now. By tapping the back icon 556, the user can go back to the display image as shown in FIG. 3.

Once the software succeeds to register the new user or log in the account of the existing user and download this user's data, the display images shown in FIGS. 3-11 are usually automatically skipped and the software logs in automatically after the software is initiated by the user. In other words, the display image for example shown in FIG. 12 is automatically created after the software finishes starting up.

### §3. Basic Functions of the Electronic Business Card Application Software

This section is explained with FIGS. 12-32 with the order shown in Table 2.

### [Table 2]

FIG. 12 shows a basic display image after the electronic business card application software is started. This figure is a typical image after the user has created several electronic business cards, collected hundreds of other people's electronic business cards, and categorized them. As shown in this figure, the electronic business cards are categorized in the categories 710 and 731-735. In the drawing, the category is called ‘STACK’. The ‘MY CARDS’ category 710 is a category in which the user's own electronic business cards 610 and 620 are categorized. The user's own electronic business cards 610 and 620 in the ‘MY CARDS’ category 710 are displayed as a default after the electronic business card application software started up. When the screen 400a is oriented in a portrait direction, the electronic business cards 610 and 620 are automatically aligned in a vertical direction. In other words, the business cards 610 and 620 are aligned so that longer edges of the electronic business cards 610 and 620 are located adjacent to each other.

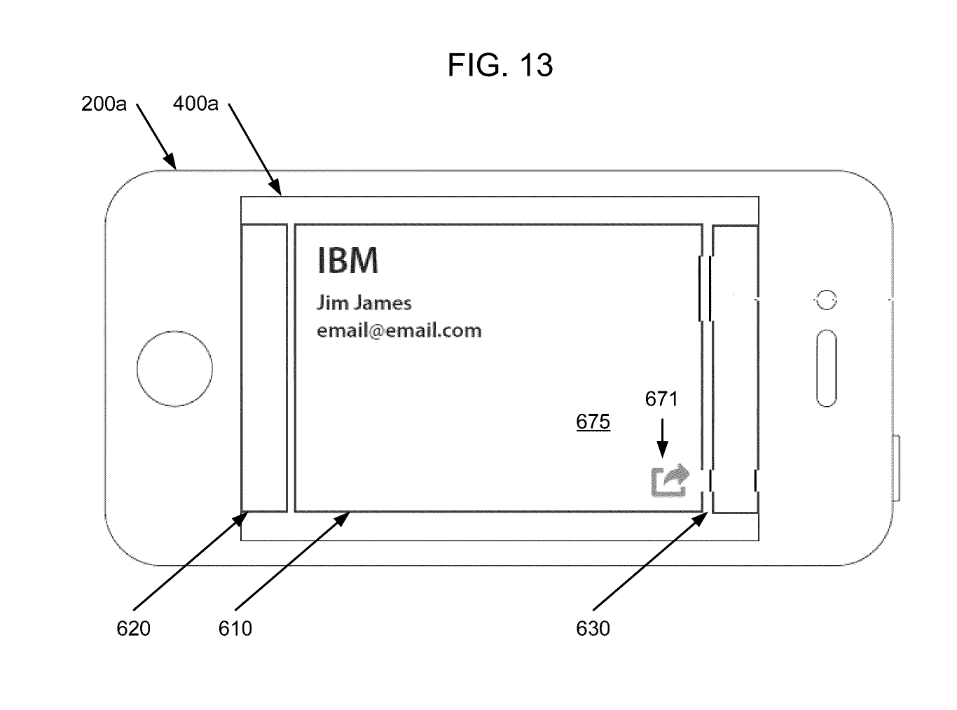

As shown in FIG. 13, when the screen 400a is rotated and oriented in a landscape manner, the categories 710, 720, 731-735 and 740 shown in FIG. 12 automatically disappear from the screen 400a and the electronic business cards 610-630 are rotated and oriented in the landscape manner. In this case, the electronic business cards 610-630 are automatically aligned in a horizontal direction. In other words, the electronic business cards 610-630 are aligned so that shorter edges of the electronic business cards 610-630 are located adjacent to each other. When the electronic business cards 610-630 are displayed in the landscape mode, one of the electronic business cards 610 is displayed in the screen 400a so that it occupies a majority of the screen. The one that is displayed as the major is for example the one that has been fully displayed on the display 400a and the one that is located at the top of all the electronic business cards that have been fully displayed. In other embodiment, the electronic business card that is displayed as the major may be the one that has been fully displayed on the display 400a and the one that is located closest to the center of the display area where the business cards are displayed. Here, one indicator of ‘majority of the screen’ is 75% or larger in terms of the area where one major electronic business card 610 is displayed to the effective area of the screen 400a that can display an image.

### §3.1 Category Function 1

Once the user again rotates the screen 400a and orients the screen 400a in the portrait direction, the display image goes back to FIG. 12. In other words, the electronic business cards 610-620 align in the vertical direction and the categories 710, 720, 731-735 and 740 appear again. At this state, when the user puts one finger on the screen 400a and inside the categories 731-735 and swipes this finger in a downward direction, the categories 731-735 scrolls in the downward direction. And, some of the categories 731-735 located closer to the bottom disappear and some new categories appear in the place closer to the top. Likewise, when the user swipes the finger in the upward direction, the categories 731-735 scrolls in the upward direction. And, some of the categories 731-735 located closer to the top disappear and some new categories appear in the place closer to the bottom.

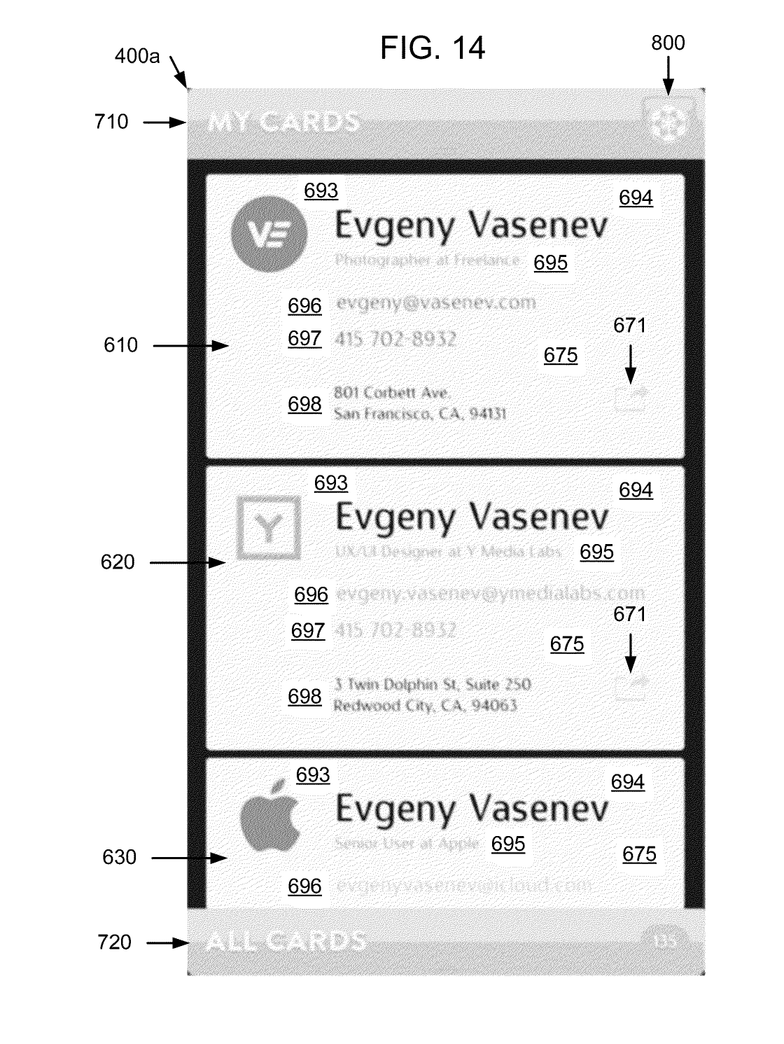

Once the user puts two fingers on the screen 400a and inside the categories 720-740 and moves these fingers so that the distance between the fingers becomes closer to each other (this motion is so-called ‘pinch in’), the display image turns like FIG. 14. At this state, all the categories 720-740 are condensed in one category 720, which is ‘ALL CARDS’ category 720. In other words, all the categories 731-740 have disappeared and only one category 720 has remained and moved to the bottom of the screen 400a. Instead, the area where the electronic business cards 610-630 are displayed has expanded, and the more electronic business cards 610-630 are displayed in one screen 400a. At this state, once the user puts two fingers on the screen 400a and around the category 720 and moves these fingers so that the distance between the fingers becomes further to each other (this motion is so-called ‘pinch out’), the display image turns back to FIG. 12.

### §3.2 Link to GPS

One remarkable feature of the electronic business card application software is that it can communicate with the GPS (Global Positioning System) function integrated in the cellular phone 200a and obtain the location where the cellular phone 200a is currently located. Once the software recognized a new location, it is capable of changing the default electronic business card to distribute by changing the electronic business card that is displayed at the first place, in other words at the top of ‘MY CARDS’ category 710. In other words, the application will move the ‘default electronic business card to the top of the ‘MY CARDS’ category 710.

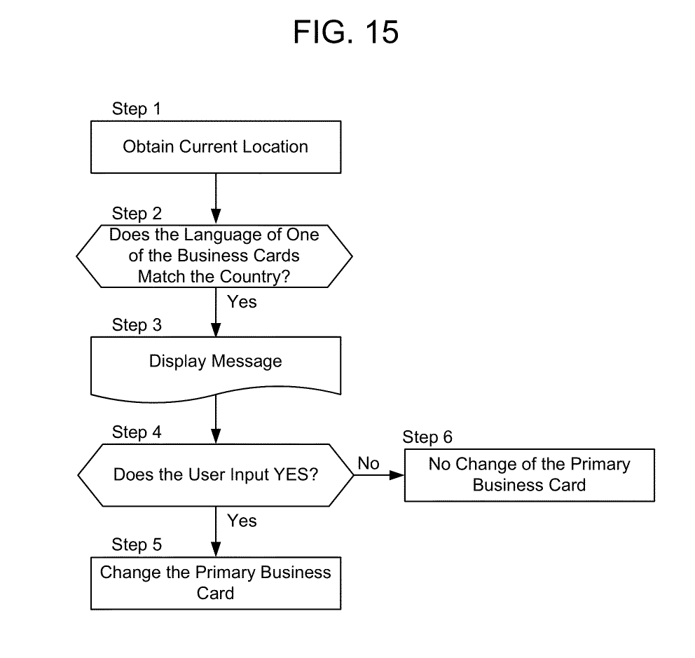

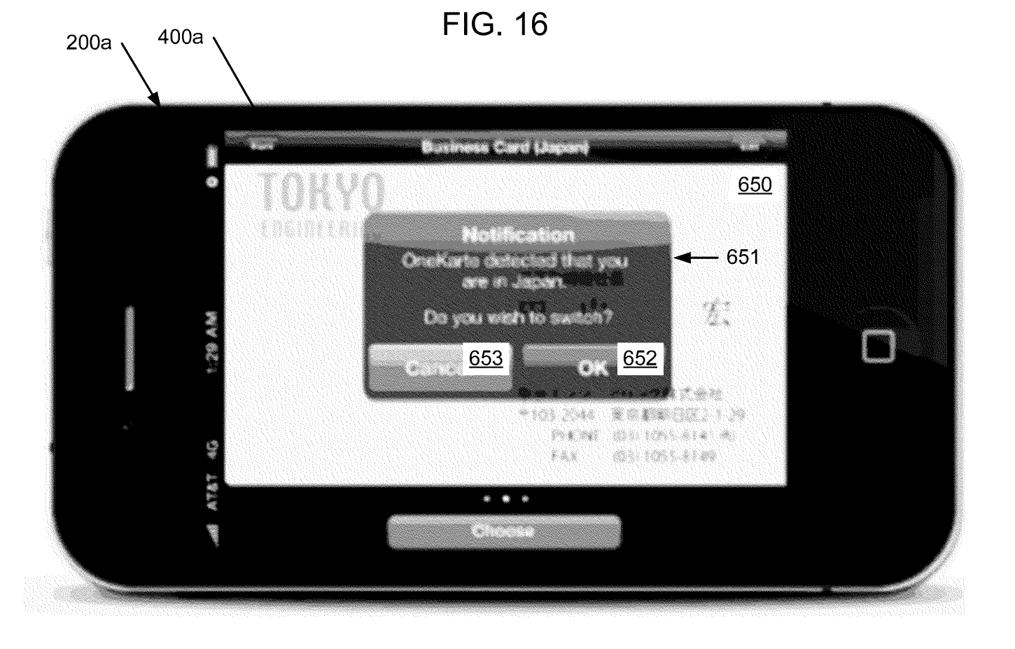

FIG. 15 shows the first procedure of how the software changes the user's electronic business card. First, the software accesses and communicates with a GPS software installed in the cellular phone 200a and obtains the location information where the cellular phone 200a is currently located (Step 1). This location includes the country in which the cellular phone 200a is currently used. Then, the software seeks the business card, from user's business cards, whose information is composed of a language that corresponds to the country in which the cellular phone 200a is currently located (Step 2). For example, when the user has arrived in Japan with the cellular phone 200a, the software seeks the user's electronic business card that is written in Japanese. In other embodiment, the software may seek the business card whose address information matches the country in which the cellular phone 200a is currently located. When such an electronic business card is found, as shown in FIG. 16, the software displays a message 651 (Step 3). The upper portion of the message 651 indicates that the user is currently located in a country different from a default country the primary business card is designed for. The lower portion of the message 651 inquires if the user wants to change the primary electronic business card, which is displayed at the top in the ‘MY CARDS’ category 710 (please refer FIG. 12) as well as which is displayed first as the major business card when the screen 400a is rotated in a landscape direction (please refer FIG. 13). As shown in FIG. 16, the message 651 is displayed in the center portion of the screen 400a. Furthermore, the candidate of the primary business card 650, which corresponds to the current country, is also displayed in the screen 400a in the landscape mode. If the user taps an ‘OK’ icon 652, the primary business card is changed (Steps 4 and 5). Of course, the user can turn down the offer by tapping a ‘Cancel’ icon 653 (Step 6).

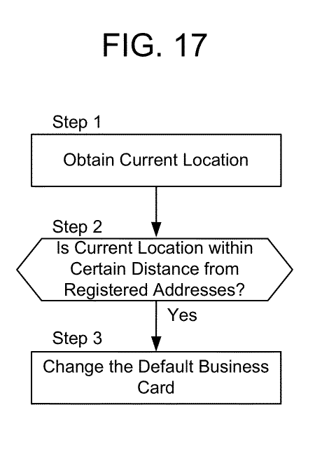

FIG. 17 shows the second procedure of how the software changes the electronic business card. To perform this procedure, the addresses registered in the user's electronic business cards are referred. First, the software obtains the location information where the cellular phone 200a is currently located (Step 1). This location includes the address at which the cellular phone 200a is currently used. Then, the software determines if there is/are one or plural user's electronic business cards whose registered address is within a certain distance from the current address (Step 2). For example, when the user is in the office at work, the software remains the user's default electronic business card as the primary electronic business card in the case that the address registered in the default business card is the office address. On the other hand, when the user is at home, the software switches the user's secondary electronic business card as the primary electronic business card in the case that the address registered in the secondary business card, which can be his private business card, is the home address. When plural cards are found, the electronic business card that is at the highest priority, the one arranged closest to the top in the ‘MY CARDS’ category 710 (please refer FIG. 12), may be set as the default electronic business card. When such an electronic business card is found, the found business card is set as the default electronic business card (Step 3).

### §3.3 Category Function 2

Now, the explanation goes back to the categories shown in FIG. 12. As explained before, the electronic business cards are categorized in the categories 710 and 731-735. The ‘MY CARDS’ category 710 is a category in which the user's own electronic business cards 610 and 620 are categorized. The categories 731-735 are created by the user, and usually most of the electronic business cards are categorized into one of the categories 731-735 by the user. An ‘ALL CARDS’ item 720 is an item in which all the electronic business cards stored in the cellular phone 200a are displayed once the ‘ALL CARDS’ item 720 is tapped. The item ‘+ADD NEW STACK’ 740 is an item for creating a new category.

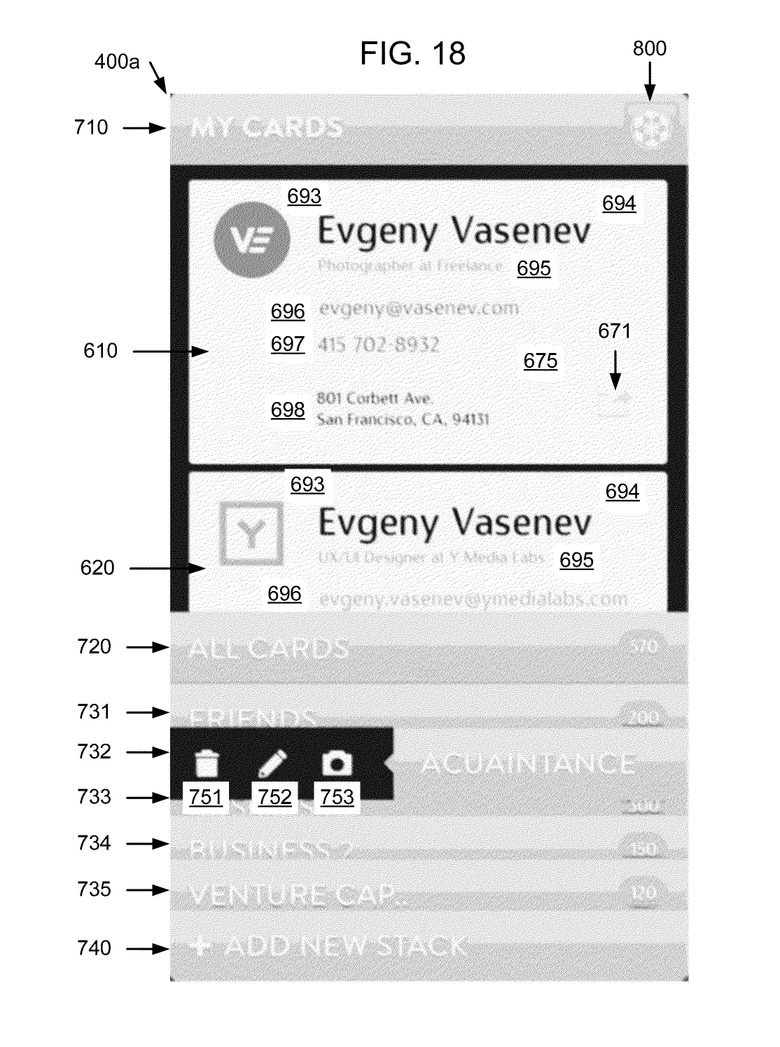

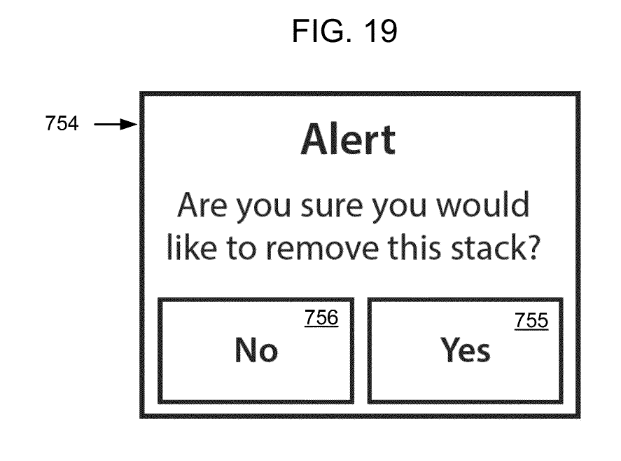

Once the user puts a finger on one of the stacks 731-735, for example the ‘ACQUAINTANCE’ category 732, and swipes the finger from left to right, in other words in the horizontal direction, the display image turns like FIG. 18. As shown in this figure, now the word ‘ACQUAINTANCE’ moved to right and three icons 751-753 have shown up in the left portion of the category 732. When the user taps the Delete icon 751, a message 754 shown in FIG. 19 is shown in the center of the screen 400a. The message 754 asks if the user wants to remove the selected category, in this case the ‘ACQUAINTANCE’ category 732. When the user taps the ‘Yes’ icon 755, all the electronic business cards categorized in this category are moved to a category ‘Trash’ (not shown in the figure), and the selected category, for example the ‘ACQUAINTANCE’ category 732, is deleted. Of course, the user can select ‘No’ icon 756. Going back to FIG. 18, when the user taps the Rename icon 752, the user can change the name of the selected category. When the user taps the Scan icon 753, the user can scan a paper business card and the scanned business card is categorized in this category. The function of scan of this application software is described later.

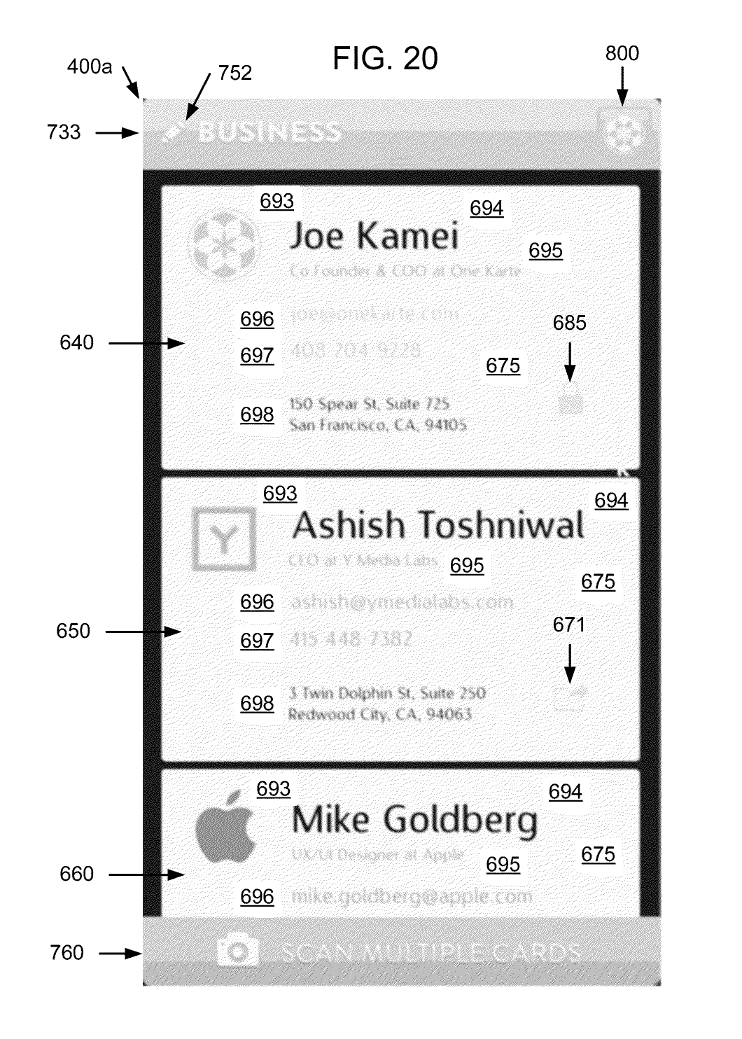

Going back to FIG. 12, when the user taps one of the categories 731-735, for example the ‘Business’ category 733, the display image turns like FIG. 20. Now, all other categories have disappeared from the screen 400a and only the ‘Business’ category 733 is displayed. Below the ‘Business’ category 733, other people's electronic business cards 640-660 that are categorized in the ‘Business’ category 733 are displayed. When the user swipes one of the electronic business cards 640-660 with a finger in an upward or a downward direction, the electronic business cards 640-660 scroll in the upward or the downward direction. When the electronic business cards 640-660 are moved in the upward direction, some of the electronic business cards 640-660 located in the upper portion of the screen 400a disappear and other electronic business cards appear in the lower portion of the screen 400a. Likewise, when the electronic business cards 640-660 are moved in the downward direction, some of the electronic business cards 640-660 located in the lower portion of the screen 400a disappear and other electronic business cards appear in the upper portion of the screen 400a. By repeating the swipe, the user can eventually see all the electronic business cards that are categorized in the ‘Business’ category 733.

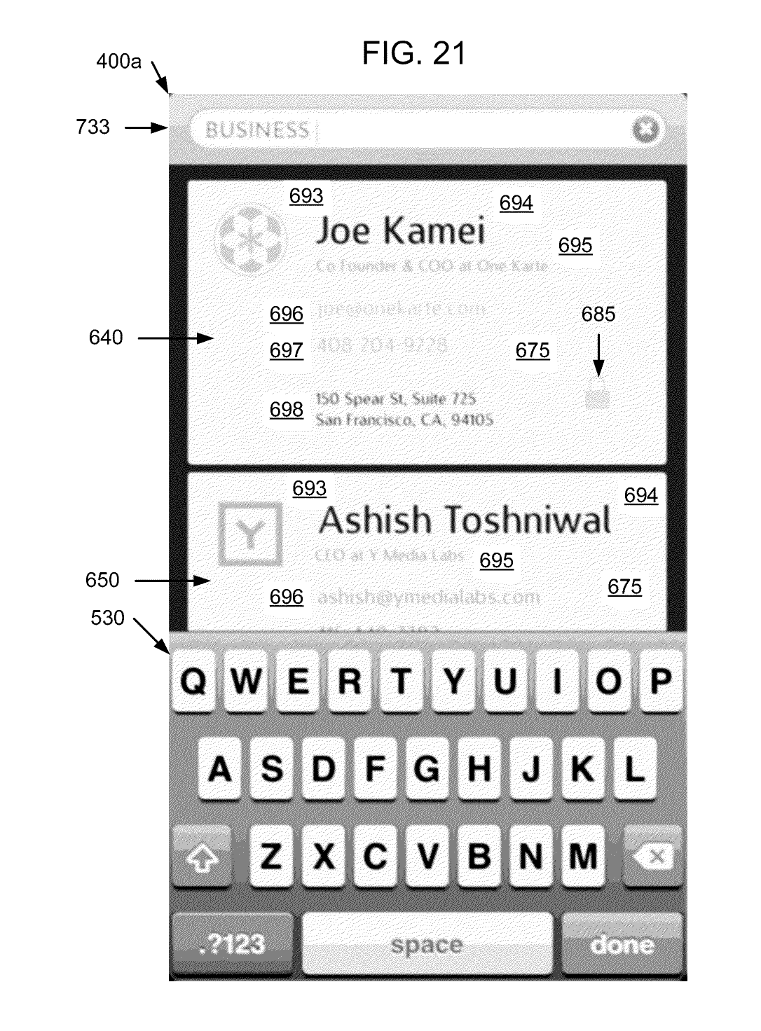

In the left portion of the ‘Business’ category 733, just left by the word ‘Business’, a Rename icon 752 is displayed. Once the user taps the Rename icon 752, the display image turns like FIG. 21. There, the user can rename the name of the ‘Business’ category 733 through the on-screen keyboard 530. Going back to FIG. 20, when the user taps an item ‘SCAN MULTIPLE CARDS’ 760, the user can scan plural paper business cards at one time and all the scanned business cards are categorized in this category, which is the ‘Business’ category 733. Of course, when the item 760 is tapped at a state where other category is opened, scanned paper business cards are categorized in this other category. The function of the multiple scan is explained later.

### §3.4 Business Card

Some electronic business cards such as electronic business cards 640-660 shown in FIG. 20 contain backside information. When the electronic business cards 640-660 are electronically created, the backside information is a virtual backside of the electronic business cards 640-660 designed by the creators of the electronic business cards 640-660. When the electronic business cards 640-660 are created by scanning and the backsides of the paper business cards are scanned, the backside information is a scanned image of the backside of the paper business card. The application software also provides a backside function similar to memos or marks many people write down on the backside after receiving a paper business card. Conceptually, the information shown in the front side of the electronic business card is the one that the creator of the electronic business card has inputted while the information shown in the backside of the electronic business card can include both the one that the creator of the electronic business card has inputted and the one that the person who received the electronic business card has inputted.

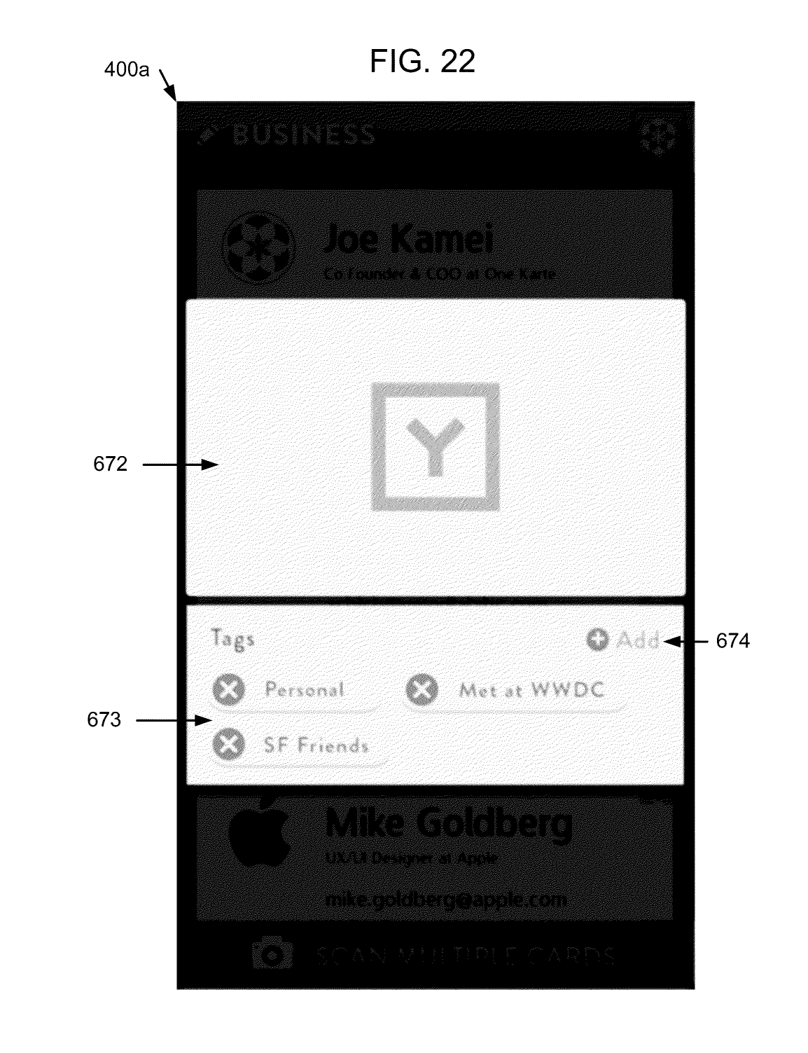

As shown in FIG. 20, the electronic business cards 640-660 contain a white space 675. The ‘white space’ generally refers to a place where letters, logos or icons do not occupy in the displayed electronic business cards. When the white space 675 of, for example, the electronic business card 650 is tapped, the display image turns like FIG. 22. In the upper middle portion of the screen 400a, an image of the backside 672 of the electronic business card is displayed when the electronic business card contains such kind of data. Below the backside image 672, keywords 673 are displayed. In the figure, the keywords are named as ‘Tags’. These keywords 673 were defined and added by the user often for better remembering the met person or meeting situation.

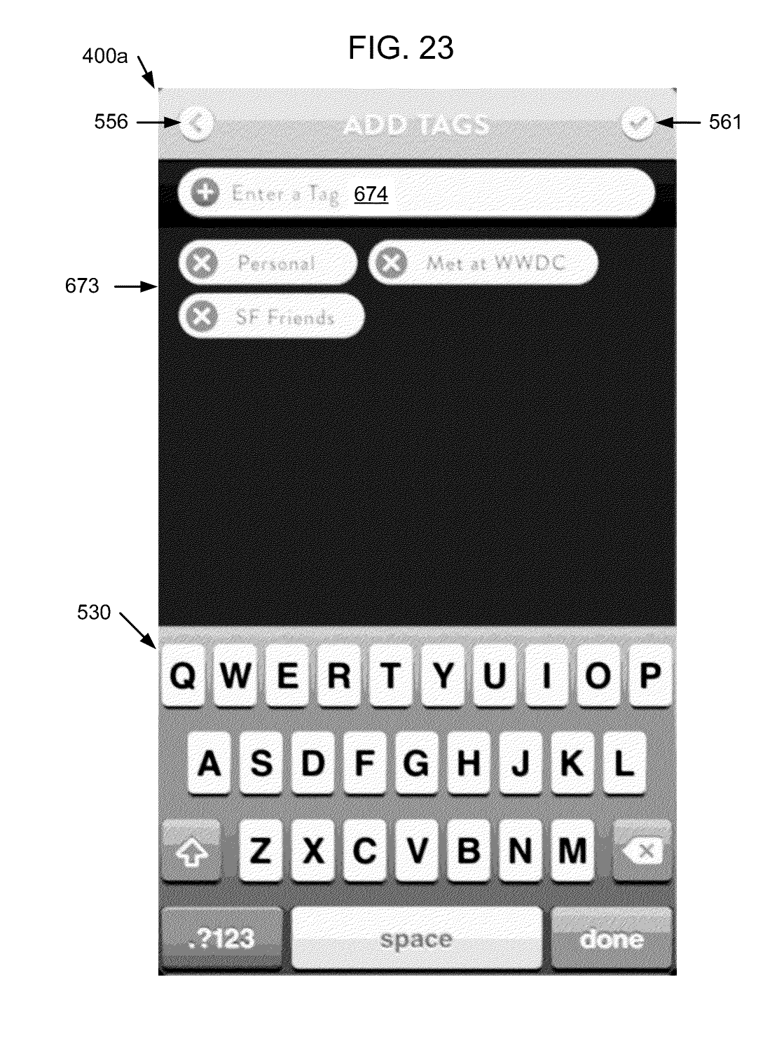

When a ‘+ Add’ icon 674 is tapped, the display image turns like FIG. 23. There, by tapping a ‘+ Enter a Tag’ item 674, the user can add a new keyword through the on-screen keyboard 530. Further, the user can delete the keywords 673 by tapping an ‘X’ icon indicated left by the name of the keyword. Once the editing of the keywords 673 is done, the user taps the finish icon 561. Thereby, the modified keywords 673 are saved. Or, the user can go back to FIG. 22 with discarding the modification by tapping the back icon 556.

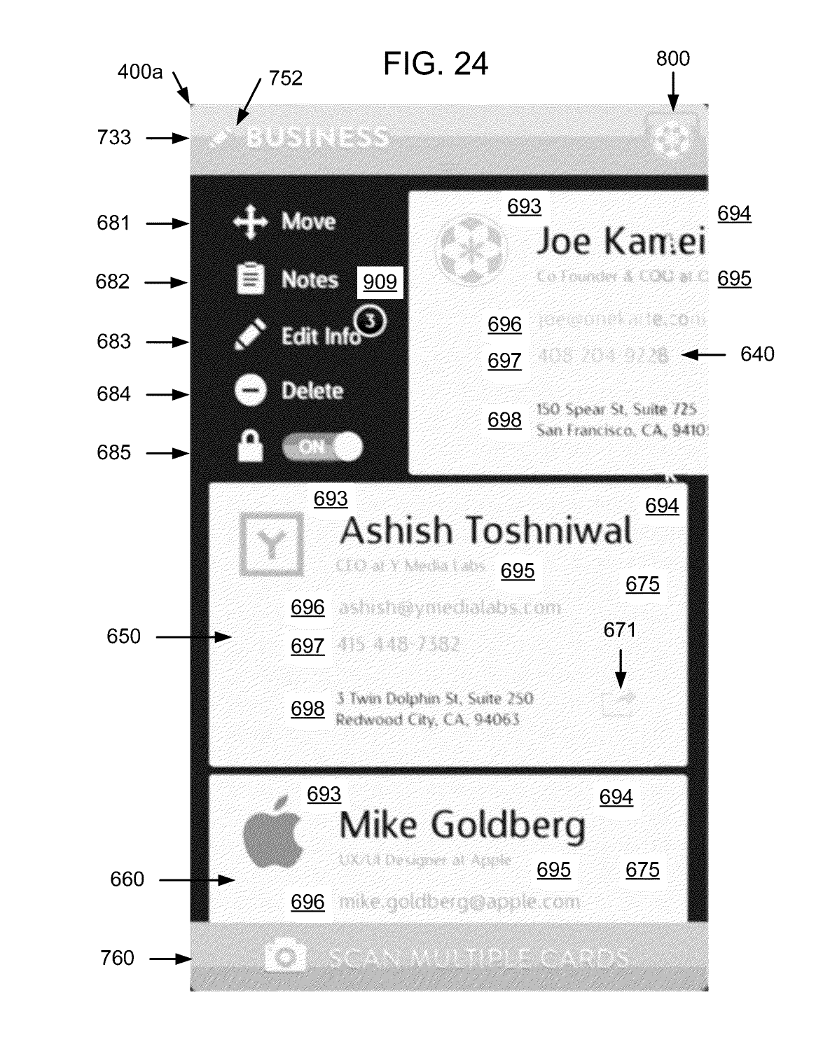

Going back to FIG. 20, when the user puts a finger on one of the electronic business cards, for example the electronic business card 640, and swipe the finger from left to right, the display image turns like FIG. 24. As shown in this figure, the electronic business card 640 has moved to the right, and operation icons 681-685 showed up. By tapping these icons 681-685, the user can work on the electronic business card 640.

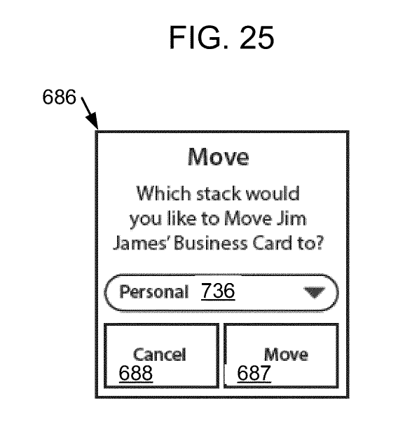

When the ‘Move’ icon 681 is tapped, a portion of the display image turns like FIG. 25. A message 686 is displayed in the center portion of the screen 400a. The message asks the user where the user wants to move the selected electronic business card 640. Then, the user selects the destination category 736. When the user taps a ‘Move’ icon 687, the electronic business card 640 is moved to the other category 736. If the user taps a ‘Cancel’ icon 688, the electronic business card 640 is not moved to other category.

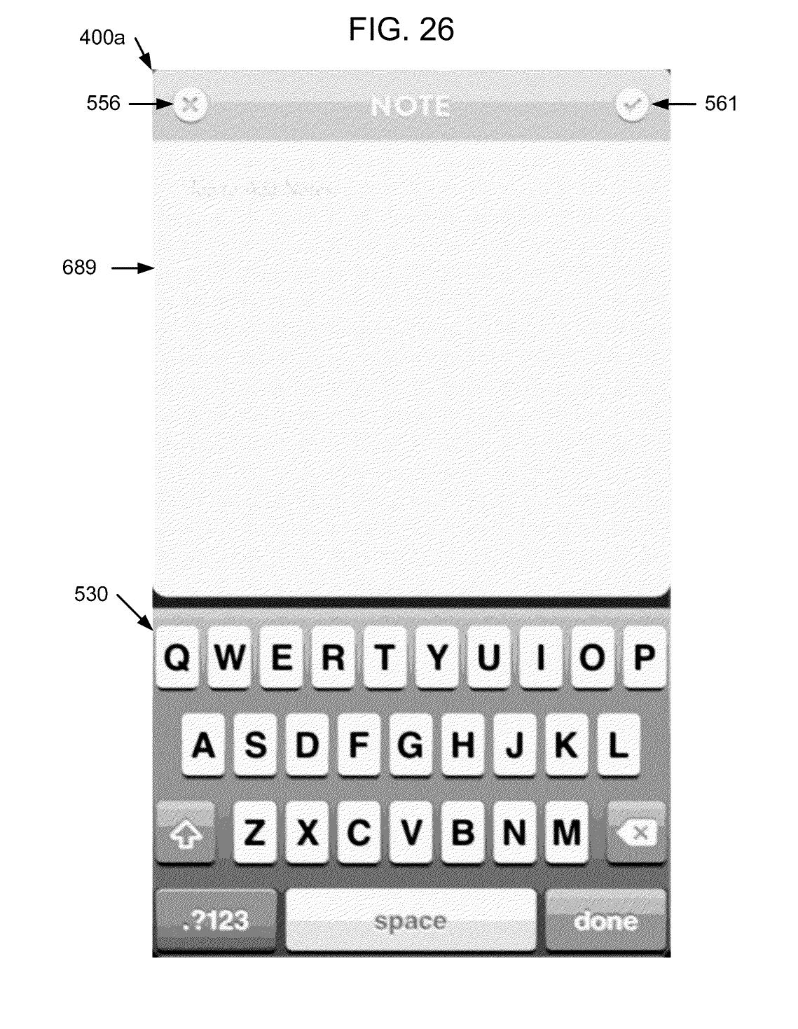

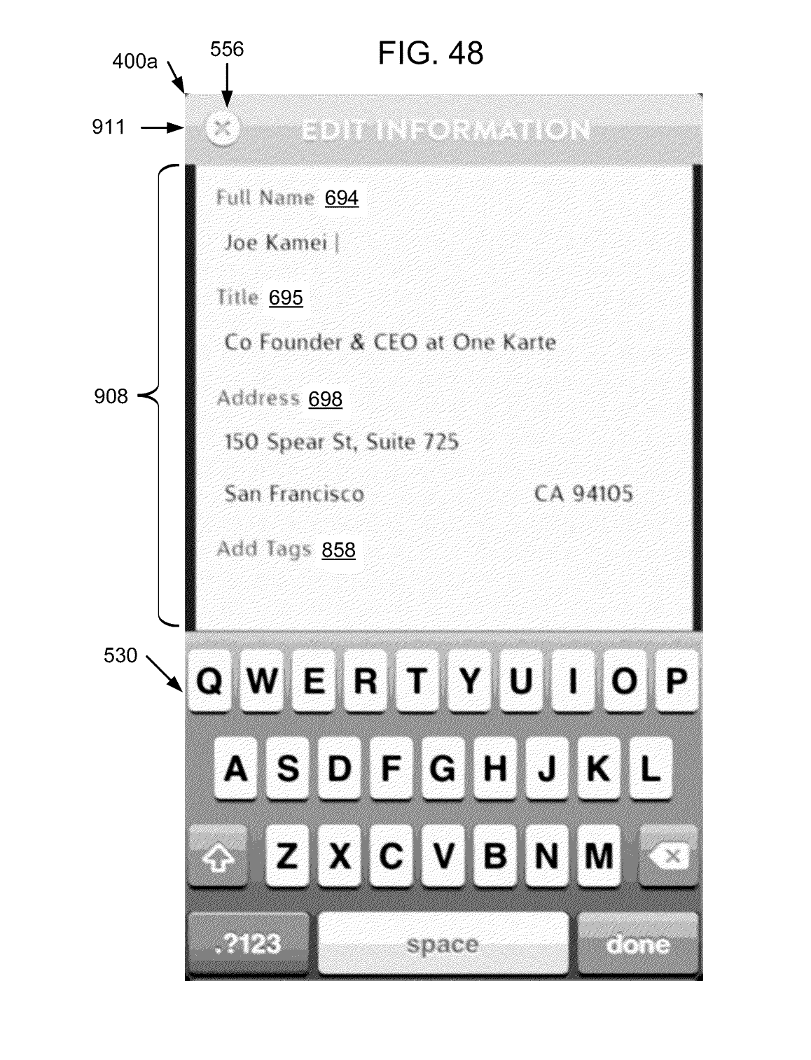

Going back to FIG. 24, when the ‘Notes’ icon 682 is tapped, the display image turns like FIG. 26. As shown in this figure, a ‘Note’ section 689 has appeared in the upper part of the screen 400a, and the user can type memos in the ‘Note’ section 689 through the on-screen keyboard 530. When the ‘Edit Info’ icon 683 is tapped, the display image turns like FIG. 48, and the user can edit information of the electronic business card 640 such as the person's name 694, the company name and title 695, the e-mail address 696, the telephone number 697 and the address 698. The function of the ‘Edit Info’ is explained later.

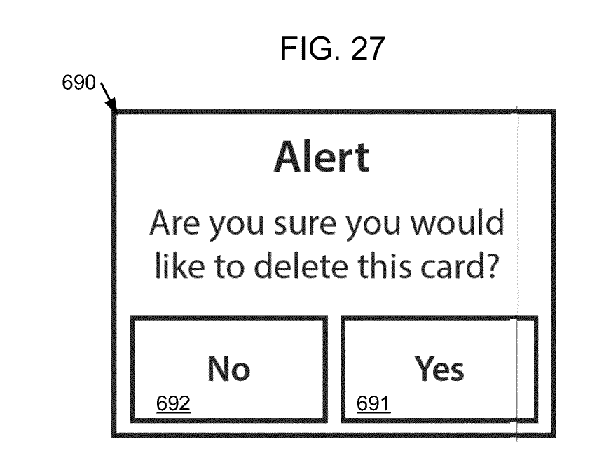

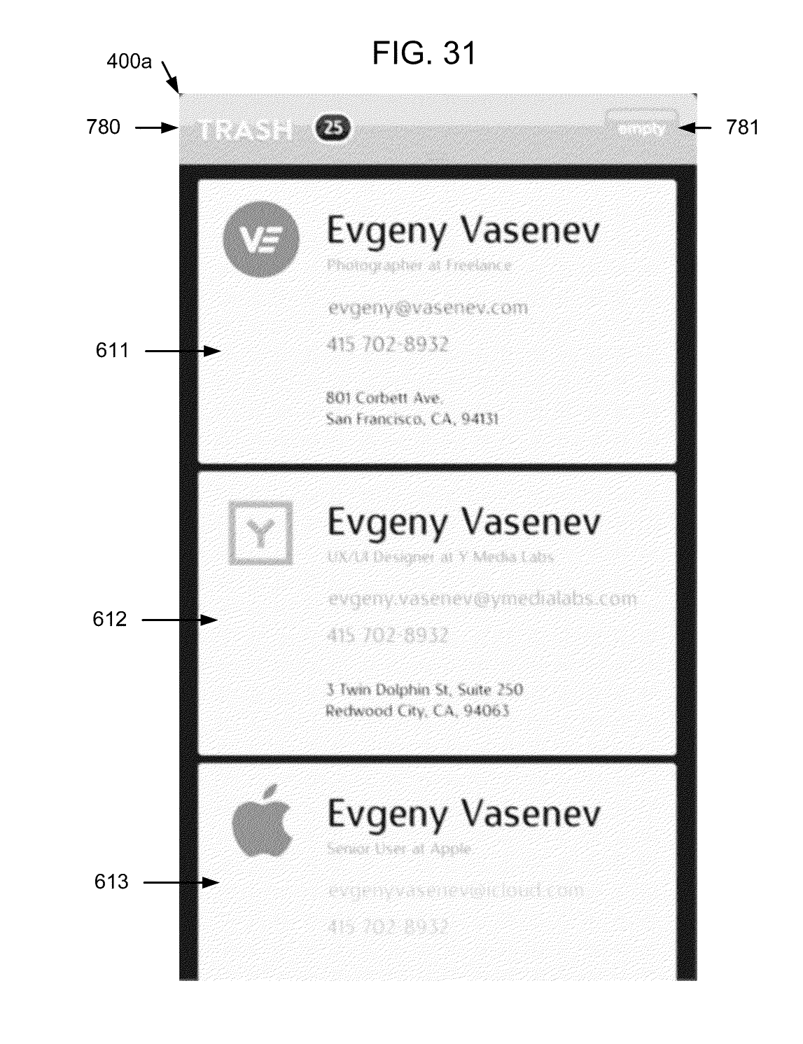

When the ‘Delete’ icon 684 is tapped, a center portion of the display image turns like FIG. 27. A message 690 is displayed in the center portion of the screen 400a. The message asks the user to confirm to delete the selected electronic business card 640. When the user taps a ‘Yes’ icon 691, the electronic business card 640 is moved to the category ‘Trash’ (please refer FIG. 31). If the user taps a ‘No’ icon 692, the electronic business card 640 is not deleted.

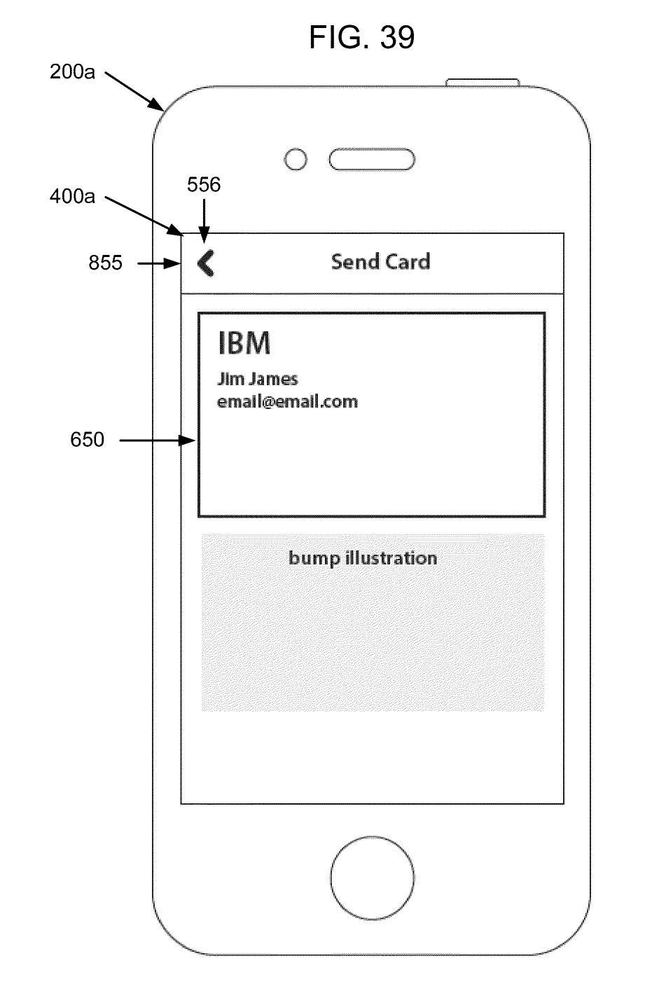

A private icon 685 is displayed at the bottom of the operation icons 681-685 in FIG. 24. This icon is unique in that nothing happens even when the user taps this private icon 685. Rather, this icon represents that the selected electronic business card 640 is set as private by the creator of this business card, not by the user. This private icon 685 represents that the distribution of this electronic business card 640 to another person is prohibited. Thus, the user cannot send the data of electronic business card 640 to other person. When the electronic business card 640 is set as private, the private icon 685 is also placed on the front side of the electronic business card 640 as shown in FIGS. 20 and 21. When the electronic business card 640 is set as ‘Public’, the private icon 685 is replaced by a Send icon 671, which has a similar appearance of ‘→’. After this Send icon 671 is tapped by the user, the display image turns like FIG. 39 and the electronic business card 640 is sent to another person with a proper operation. The send of the electronic business card is explained later.

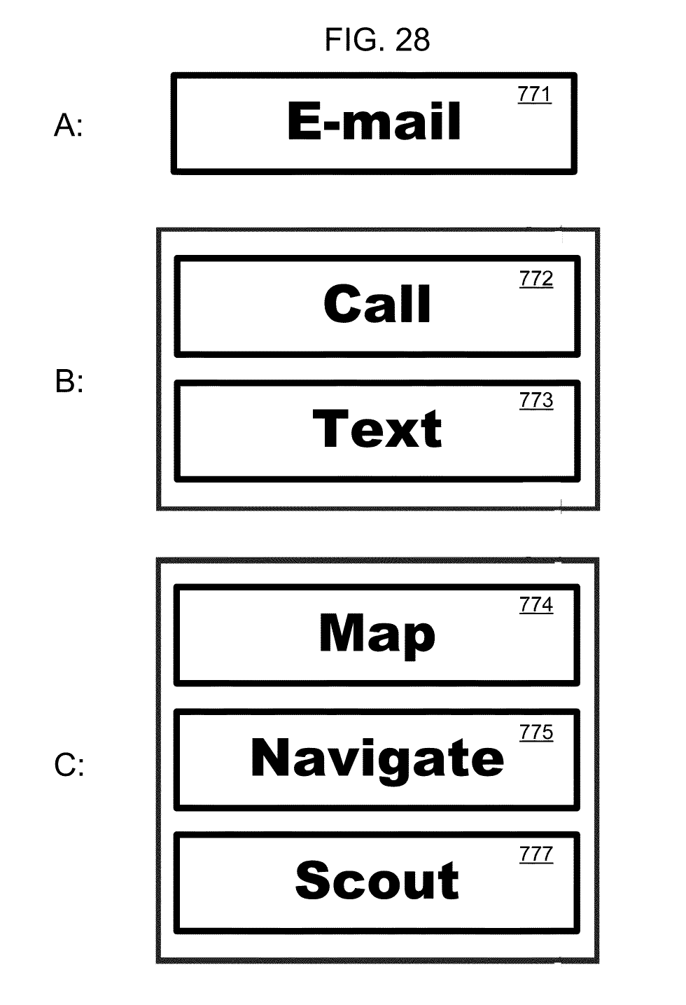

As shown in FIG. 20, each of the electronic business cards 640-660 contains a logo 693, a person's name 694, a company name and title 695, an e-mail address 696, a telephone number 697, and an address 698. One big feature of the electronic business card application software is to utilize these expressions to easily contact to the person of the electronic business card 640. When the user taps the e-mail address 696, as shown in FIG. 28A, an ‘E-Mail’ icon 771 shows up in the screen 400a. Once the user taps the ‘E-Mail’ icon 771, the electronic business card application software runs an e-mail software installed in the cellular phone 200a and arrange the cellular phone 200a so that the user can type an e-mail with its recipient section automatically filled with the e-mail address 696. Going back to FIG. 20, when the user taps the telephone number 697, as shown in FIG. 28B, a ‘Call’ icon 772 and a ‘Text’ icon 773 show up in the screen 400a. Once the user taps the ‘Call’ icon 772, the electronic business card application software operates the cellular phone 200a and makes it call to the telephone number 697. Once the user taps the ‘Text’ icon 773, the software operates the cellular phone 200a and arranges it so that the user can type a text message of Short Message Service (SMS) with its recipient section automatically set as the telephone number 697.

### §3.5 Map Function

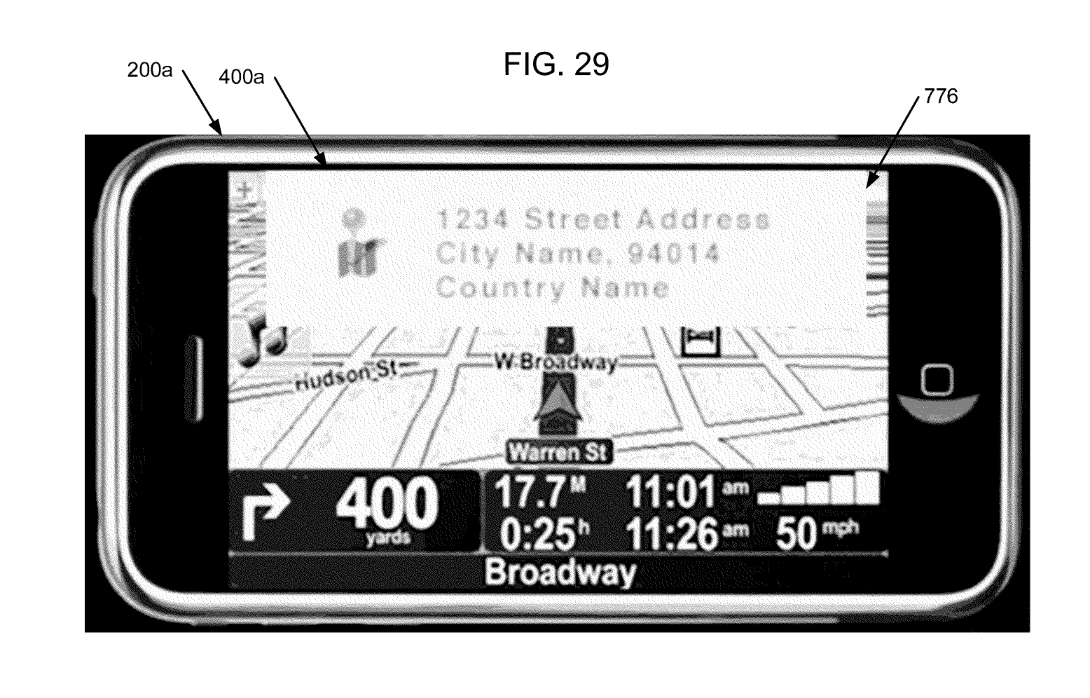

Again going back to FIG. 20, when the user taps the address 698, as shown in FIG. 28C, a ‘Map’ icon 774, a ‘Navigate’ icon 775 and a ‘Scout’ icon 777 show up in the screen 400a. Once the user taps the ‘Map’ icon 774, the electronic business card application software runs and/or switches to a map software such as Google Maps™. Then, the application software sends the address 698 to the map software and configures it so that the map software shows a map around the address 698 and the map software indicates the location of the address 698 in the map. When the user taps the ‘Navigate’ icon 775, the application software also runs a map software like Google Maps™. Then, the software sends the address 698 to the map software 776, and as shown in FIG. 29, it configures the map software 776 so that the map software 776 shows a direction to reach the location of the address 698 as a destination from the place where the cellular phone 200a is currently located.

### §3.6 Scout Function

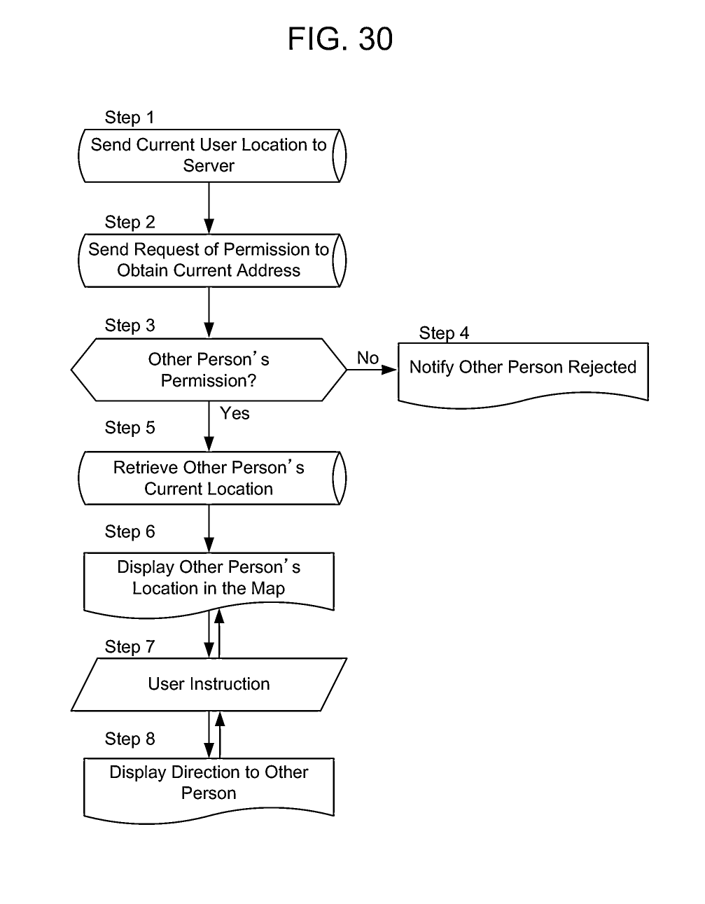

When the ‘Scout’ icon 777 is tapped, a scout function is initiated. The Scout function is one feature of the electronic business card application software that sets it apart. It is a function that provides information about where the person named in the electronic business card 650 is currently located, utilizing the GPS function of a cellular phone. As shown in FIG. 30, once the user taps the ‘Scout’ icon 777, the electronic business card application software sends information about where the cellular phone 200a is currently located to the server 100 (please refer FIG. 1) (Step 1). Also, the software sends a request to the server 100 (Step 2). Then, the server 100 forwards this request to the cellular phone 200b, whose owner is the person named in the electronic business card 650. This is a request asking permission if this person permits to notify where this person is currently located to the user. If this person responds Yes, the electronic business card application software installed in the cellular phone 200b sends the server 100 the permission and the current location information where the cellular phone 200b is currently located. When the person responds “No” by selecting from the options (Step 3), the information that the person turned down the request is also sent to the server 100. Then, this information is sent to the electronic business card application software of the user's cellular phone 200a from the server 100. Then, the cellular phone 200a notifies the user that the person of the electronic business card 650 turned down the request to tell his/her current location to the user (Step 4). When the cellular phone 200a receives the other user's Yes response (Step 3), the software also obtains this user's current location from the server 100 (Step 5). Then, the software operates the map software and configures it so that the map software shows a map around the place where the other user is current is located (Step 6). Furthermore, the software can instruct to the map software to show the direction from where the user is currently located to where the other person is currently located upon user's instruction (Steps 7 and 8). Also, the other person can obtain where the user is currently located once the other person permits to notify to the user where the other person is currently located. Thereby, both the user and the other person can share the information about where both two are currently located.

### §3.7 Trash

Although not depicted in FIG. 12, there is a category called ‘Trash’. This ‘Trash’ category 780 appears by scrolling the categories 731-735. Once the ‘Trash’ category 780 appears and this category 780 is tapped, the display image turns like FIG. 31. Under the ‘Trash’ category 780, electronic business cards 611-613 that have been deleted by the user are stored and displayed.

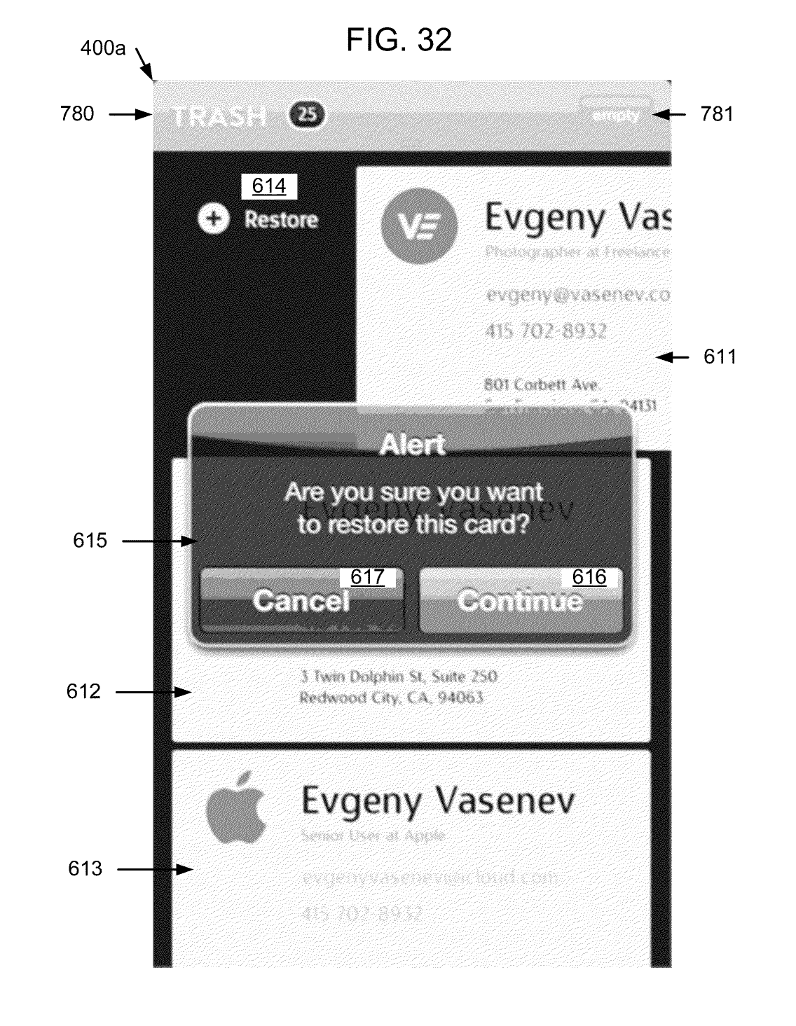

Once the user swipes one of the electronic business cards to the right, for example electronic business card 611, the display image turns like FIG. 32. The electronic business card 611 moves to the right, and a ‘+ Restore’ icon 614 shows up in the left. When the user taps this ‘+ Restore’ icon 614, a message 615 appears in the middle of the screen 400a. The message 615 asks if the user wants to restore the selected electronic business card 611. Once the user taps a ‘Continue’ icon 616, the selected electronic business card 611 is restored and placed back to the category in which it was originally categorized before it was deleted. When the user taps a ‘Cancel’ icon 617, the selected electronic business card 611 is not restored and remains in the ‘Trash’ category 780.

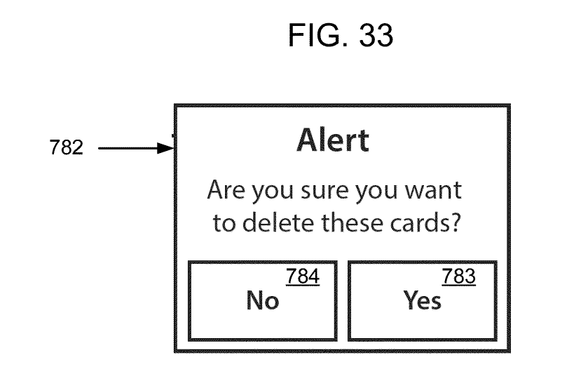

Going back to FIG. 31, in the right portion of the ‘Trash’ category 780, there is an ‘empty’ icon 781. Once the user taps this ‘empty’ icon 781, the display image turns like FIG. 33. A message 782 appears in the middle portion of the screen 400a and asks if the user wants to permanently delete the electronic business cards 611-613 that are in the ‘Trash’ category 780. If the user taps the ‘Yes’ icon 783, the electronic business cards 611-613 in the ‘Trash’ category 780 are permanently deleted from the electronic business card application software. If the user taps the ‘No’ icon 784, the electronic business cards 611-613 are not deleted and remains in the ‘Trash’ category 780.

### §4. Menu Functions of the Electronic Business Card Application Software

This section is explained with FIGS. 34-57 with the order shown in Table 3.

### [Table 3]

As shown in FIGS. 12 and 20, in the upper right portion of the screen 400a, there is an icon named Menu icon 800. Once this Menu icon 800 is tapped, icons 800-870 aligned in circle as shown FIG. 34 are displayed in the middle portion of the screen 400a. These icons 800-870 are generally associated with the functions that are not directly linked to a specific electronic business card or a category. First, when the Menu icon 800 is tapped again, the display image turns back to FIG. 20.

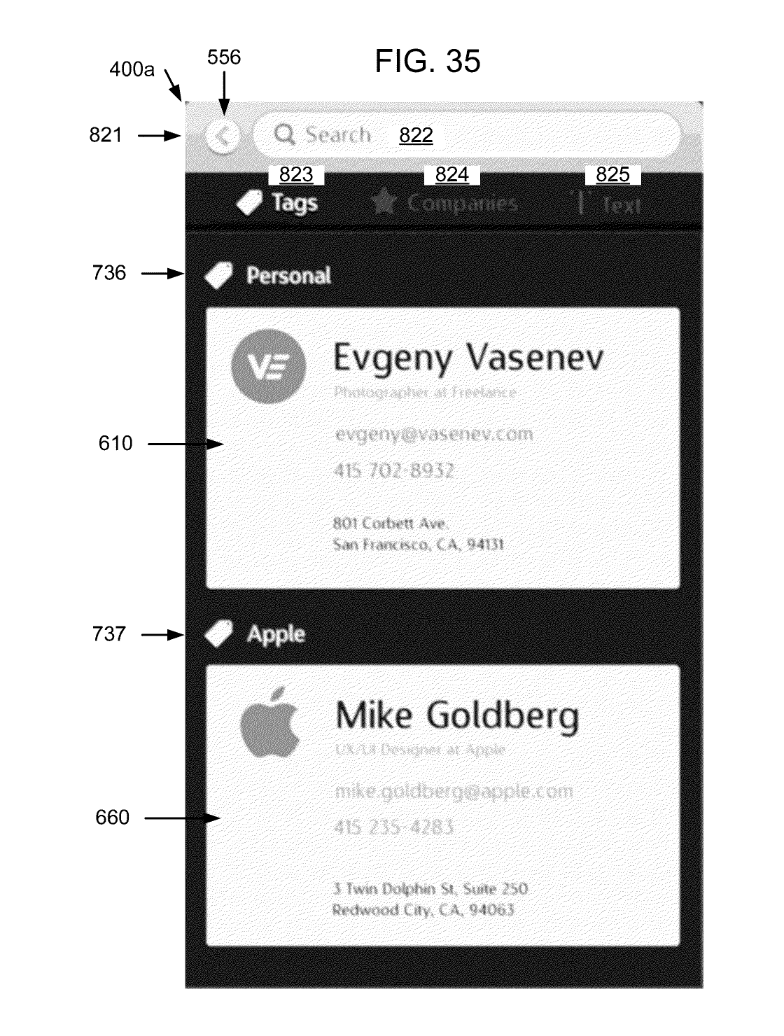

When the Search icon 820 is tapped, the display image turns like FIG. 35. As shown in this figure, a ‘SEARCH’ tab 821 is displayed in the upper part of the screen 400a. There, the user can type a search term in the search field 822. Furthermore, the user can narrow down the search criteria in which the key word search is performed. For example, when a ‘Tags’ icon 823 is tapped and activated, the search is performed only based on the words in the Tags, or categories. When a ‘Companies’ icon 824 is activated, the search is performed only based on the field of company names. When a ‘Text’ icon 825 is activated, the search is performed based on all the text data electronic business cards contain. These searches are performed across all the categories. After performing search, hit electronic business cards 610 and 660 are displayed in the screen 400a. Furthermore the categories 736 and 737 the hit electronic business cards 610 and 660 belong to are also displayed by the hit electronic business cards 610 and 660. In other embodiment, these searches can be performed only in a selected category. When a back icon 556 is tapped, the display image turns back to FIG. 34.

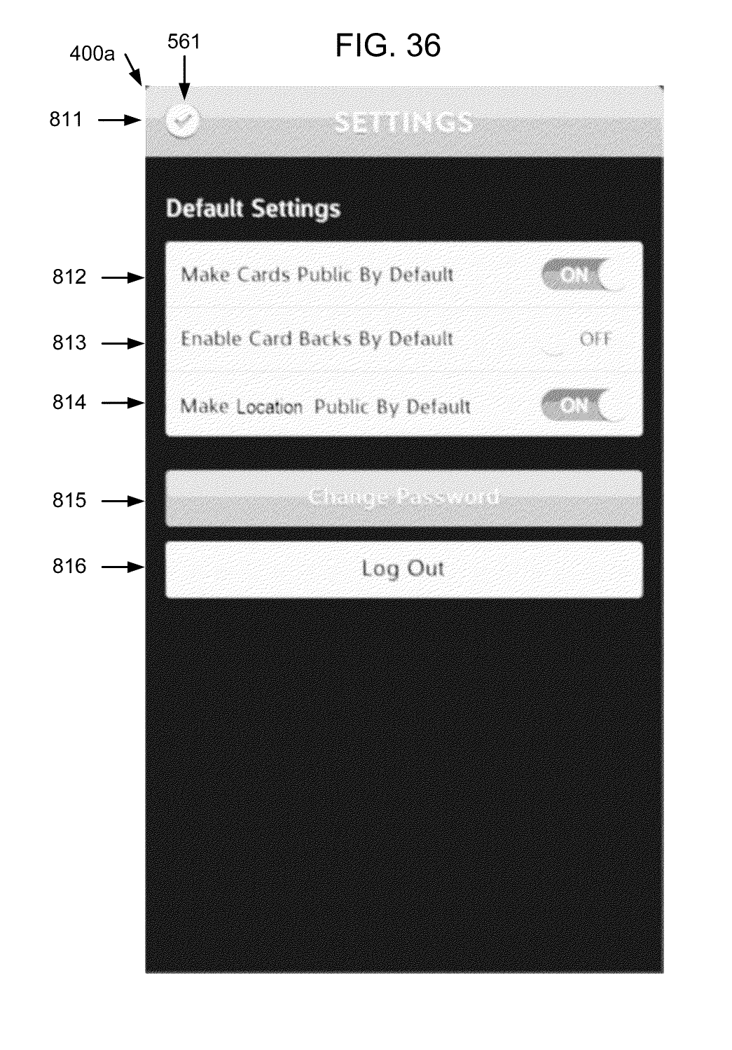

When the Setting icon 810 is tapped, the display image turns like FIG. 36. As shown in this figure, a ‘SETTINGS’ tab 811 is displayed in the upper part of the screen 400a. There, the user can change the settings of the electronic business card application software. An item “Make Cards Public By Default” 812 is for setting the property of user's electronic business cards 610-630 (please refer FIG. 14) between an allowance mode and a disallowance mode. When the item “Make Cards Public By Default” 812 is set ON, the property of the user's electronic business cards 610-630 becomes the allowance mode, and a recipient, a person who has received the user's electronic business card, can distribute the user's electronic business card to a third person. When this item “Make Cards Public By Default” 812 is set OFF, the property of the user's electronic business cards 610-630 becomes the disallowance mode, and the recipient of the user's electronic business card cannot distribute the user's electronic business card to a third person. The exchange of the electronic business cards is explained in detail later. When an item “Enable Card Backs By Default” 813 is set ON, the electronic business card application software prompts the user to capture the images of not only the front side but also the backside of the paper business card when the user scans a paper business card. When the item “Enable Card Backs By Default” 813 is set OFF, the software urges the user to capture only the images of the front side of the paper business card when the user scans a paper business card. The scan of the paper business cards is explained in detail later.

When an item “Make Location Public By Default” 814 is set ON, the Scout function (please refer FIG. 30) becomes available to the user and other users. Specifically, when the item 814 is ON, the electronic business card application software is allowed to send the user's current location information to the server 100 (please refer FIG. 1). Thus, the software automatically sends the current location information of the user to the server 100 when the software receives a permission request from other user that asks to inform the user's current location to the other user. When the item “Make Location Public By Default” 814 is set OFF, the cellular phone 200a is not allowed to send the information about the current user location to the server 100 without user's permission. When the software receives the permission request from other user, the software notifies the user that the software has received a permission request from other user that asks to inform the user's current location to other user. When the user answers ‘Yes’, the item 814 is switched to be ON and the cellular phone 200a sends the user's current location information to the server 100. When the user answers ‘No’, the cellular phone 200a does not send the user's current location information to the server 100 and the item 814 remains OFF. In other embodiment, even when the item 814 is ON, the electronic business card application software notifies the user that the software has received the permission request from other user about the user's current location. At the state where the item 814 is OFF, when the software receives a permission request from other user, the software discards its request and does not even notify the permission request to the user. In other embodiment, the electronic business card application software may not have such kind of setting criterion by itself and may just follow the setting of map function or software installed in the cellular phone 200a.

The user can change his/her login password by selecting an item “Change Password” 815. The user can also logoff the current account of the application software by selecting an item “Log Out” 816. After the user finishes changing the setting, the finish icon 561 is tapped. Then, the display image turns back to FIG. 34.

By tapping the Create icon 860, the user can create a new yet another his/her own electronic business card, following the procedure explained with FIGS. 6-10.

### §4.1 Exchange of Electronic Business Cards

One big feature of the electronic business card application software is that it enables the users to exchange their electronic business cards or other person's electronic business card just by placing the two electronic devices, for example the cellular phones 200a and 200b, close to each other. This process is typically initiated by tapping the Exchange icon 850.

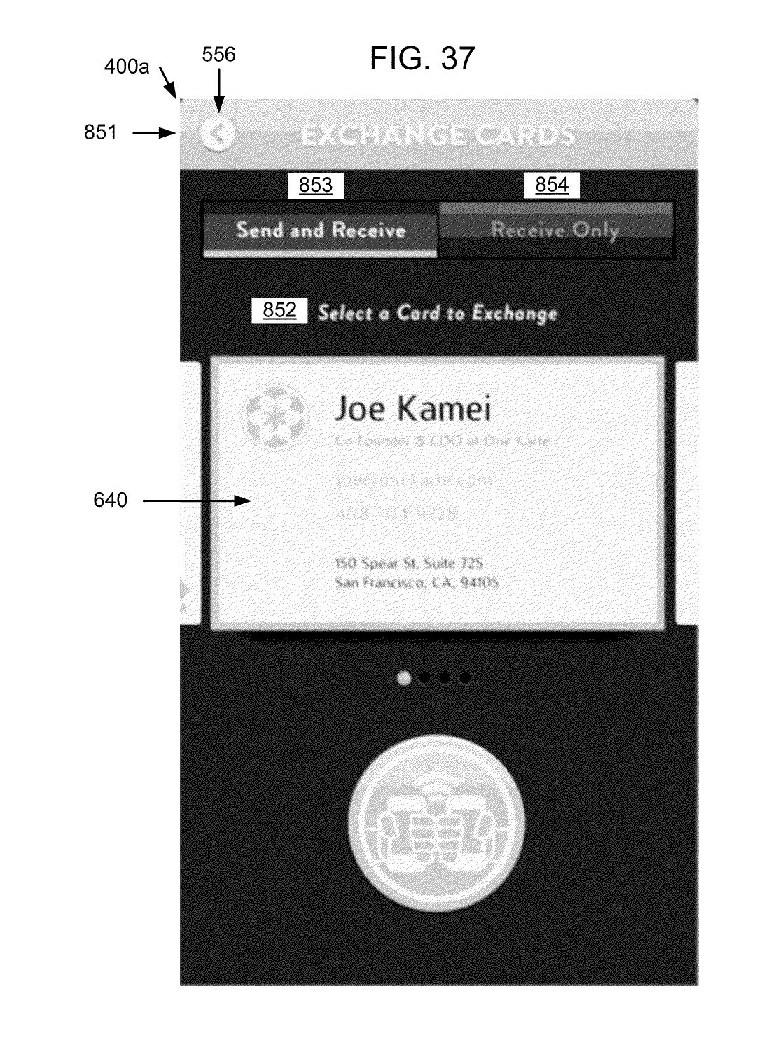

When the Exchange icon 850 is tapped, the display image turns like FIG. 37. As shown in this figure, an ‘EXCHANGE CARDS’ tab 851 is displayed in the upper part of the screen 400a. In the upper middle of the screen 400a, a message 852 is displayed. This message 852 urges the user to select an electronic business card the user wants to exchange. Below this message 852, a candidate electronic business card 640 that is going to be exchanged is displayed. By swiping the electronic business card 640 from left to right or right to left, in other words in the landscape direction, the user can change the candidate electronic business card to exchange.

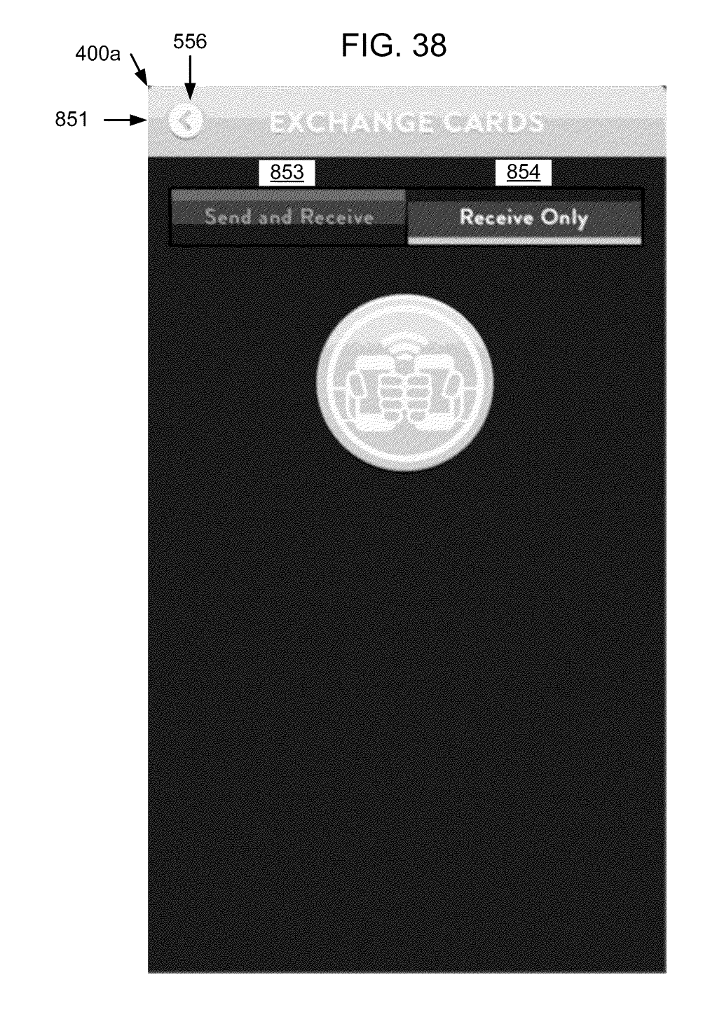

In the case of FIG. 37, a ‘Send and Receive’ tab 853 is active. When the user taps a ‘Receive Only’ tab 854, the display image turns like FIG. 38. In this case, the cellular phone 200a is already ready to receive other person's electronic business card.

There is an alternative way to send an electronic business card. Going back to FIG. 20, when an electronic business card 650 is allowed to distribute to other people, a Send icon 671 is displayed in the electronic business card 650. Once this Send icon 671 is tapped by the user, the display image turns like FIG. 39. As shown in this figure, a ‘SEND CARD’ tab 855 is displayed in the upper part of the screen 400a. Below this tab 855, the electronic business card 650 selected to send by the user is displayed.

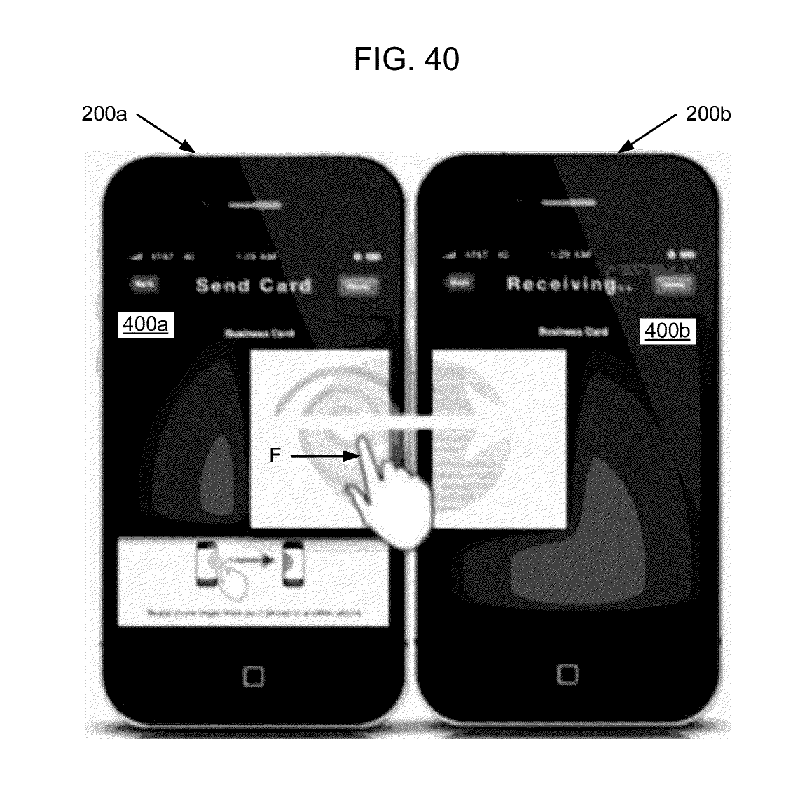

Going back to FIG. 37, once the user has finished selecting the electronic business card 640 and is ready to exchange the electronic business cards, the user and the other person, or recipient, place their cellular phones 200a and 200b close to each other as shown in FIG. 40. Here, one indicator of ‘close to each other’ is within 25 centimeters or shorter. Then, the data of the user's electronic business card 640 is transmitted from the cellular phone 200a to the cellular phone 200b as well as data of the recipient's electronic business card is transmitted from the cellular phone 200b to the cellular phone 200a. This kind of communication is achieved by utilizing technologies such as gyroscope or accelerometer, or sharing a common network connection and a commercially or freely available data transmission software. For example, the electronic business card application software can make the cellular phones 200a vibrate and transmit vibration or sound signals to the cellular phone 200b and also receive the vibration or sound signals transmitted from the cellular phone 200b. These vibrations/signals are different for each individual cellular phone and therefore act as a unique identifier, enabling to identify the user, the recipient, the user's electronic business card and recipient's electronic business card. Once the cellular phones 200a receives the key data from the cellular phones 200b, the cellular phone 200a accesses to the server 100 (please refer FIG. 1) and retrieves the other person's electronic business card data that matches the received key data. Likewise, once the cellular phones 200b receives the key data from the cellular phones 200a about the user's electronic business card, the cellular phone 200b accesses to the server 100 and retrieves the user's electronic business card data. Thereby, both the users obtain the other person's electronic business card. The inventors found that minimizing direct data exchange between the two cellular phones 100a and 100b and downloading major data of the electronic business cards from the server 100 can achieve the more stable exchange of the electronic business cards.

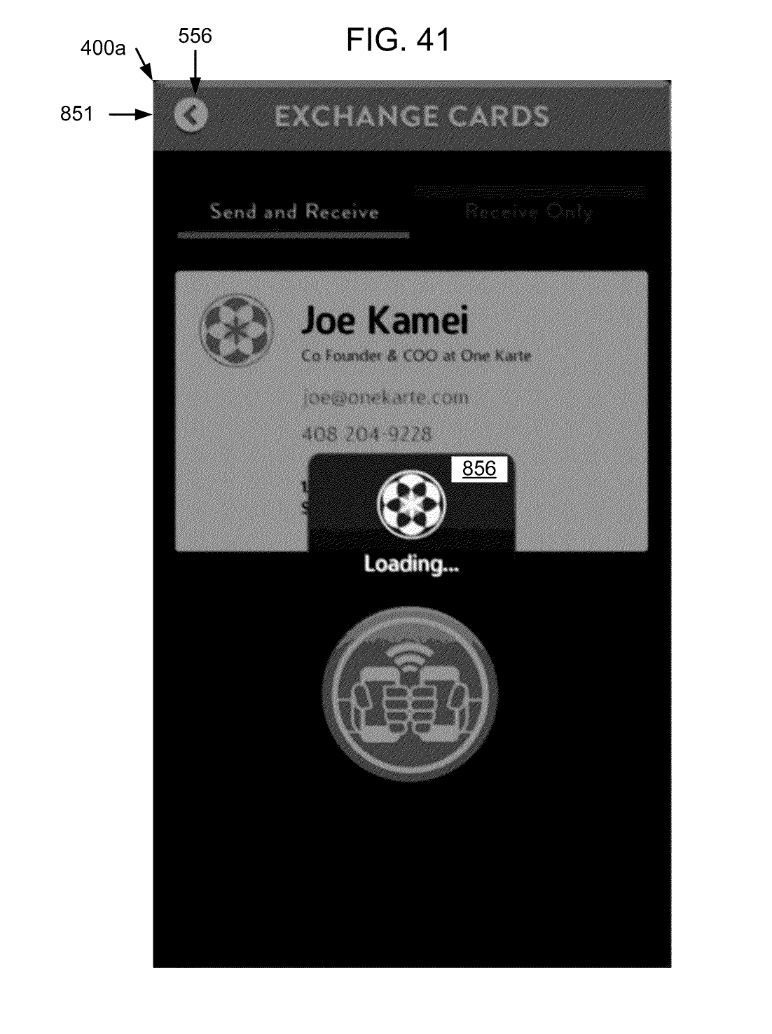

FIG. 41 is a display image while the user's cellular phone 200a is receiving the data of other person's electronic business card from the server 100. A message 856 is displayed in the center portion of the screen 400a, indicating that the application software is loading the data of other person's electronic business card.

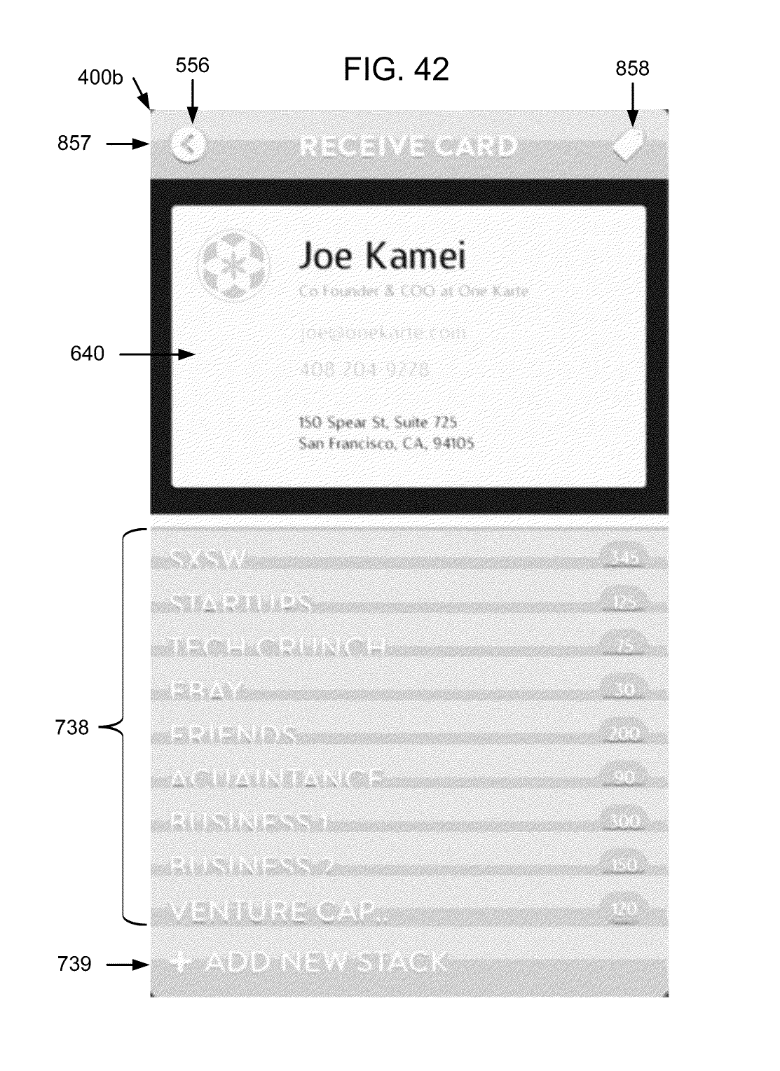

Once the data exchange is completed, the display image turns like FIG. 42. As shown in this figure, a ‘RECEIVED CARD’ tab 857 is displayed in the upper part of the screen 400b. Below this tab 857, the received electronic business card 640 is displayed. If the user taps an Add Keyword icon 858, the user can add a keyword to the received electronic business card 640. This procedure is same as the one explained with FIG. 23. Then, the user drags and drops the received electronic business card 640 into one of the categories 738. Exactly speaking, the user puts a finger on the screen 400b and on the received electronic business card 640. Then, the user slides the finger on the screen 400b onto one of the categories 738 the user wants to categorize in. Lastly, the user detaches the finger, placed on the destination category, from the screen 400b. Thereby, the received electronic business card 640 is categorized in the category the user wants to categorize in.

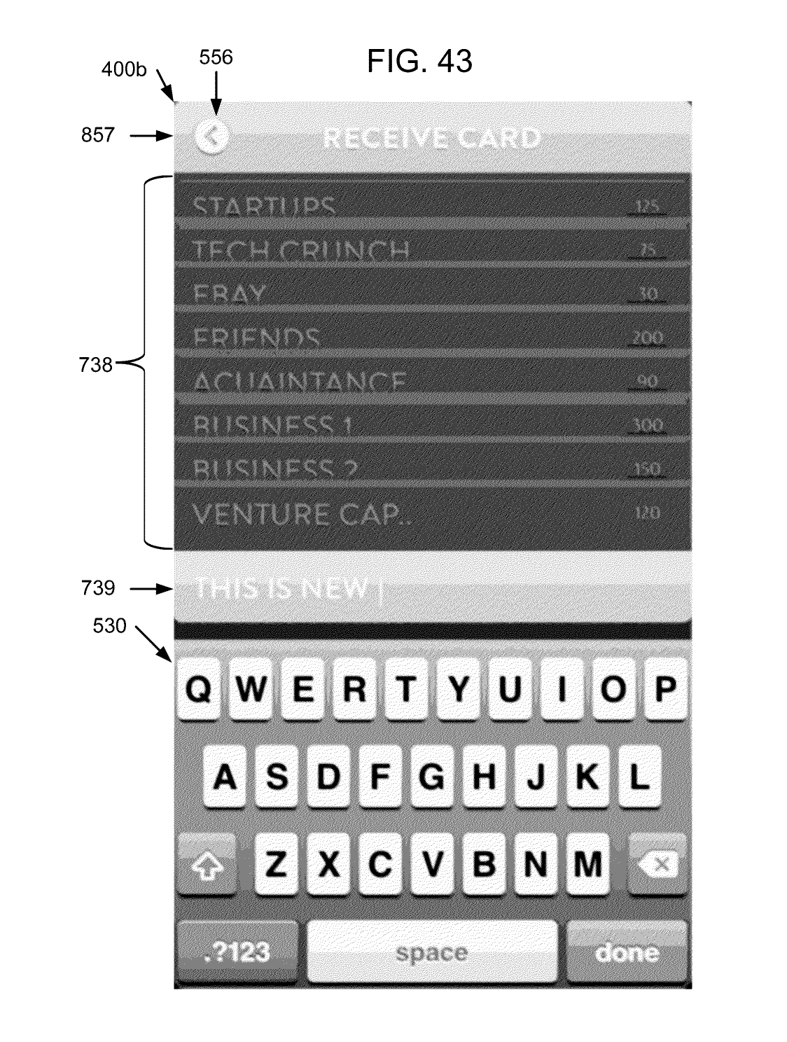

The user can add a new category. When the user taps a ‘+ ADD NEW STACK’ item 739, the display image turns like FIG. 43. As shown in this figure, the user can type a new category name in the New Stack field 739 through the on-screen keyboard 530.

### §4.2 Scan of Paper Business Cards

One brilliant feature of the electronic business card application software is that it can scan and digitize a paper business card so that the user can handle the scanned business card in the same manner as the electronically-created business card. In other words, the user can operate the electronic business cards almost in the same way regardless they are originated from a paper or electronically created in the first place.

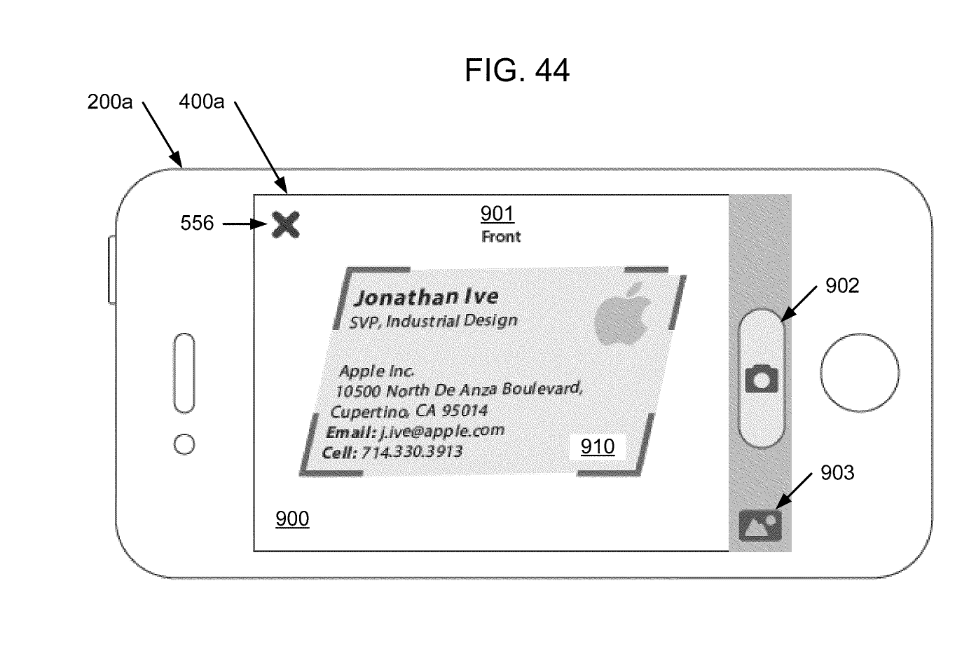

As shown in FIG. 34, there is a Scan icon 840. Once this Scan icon 840 is tapped, the display image turns like FIG. 44. First, the electronic business card application software initiates a camera the cellular phone 200a has. On the screen 400a, a camera view 900 is displayed. The camera view 900 is an image the camera is capturing real time. Also, a message 901 is displayed in the camera view 900 to prompt the user to take a picture of front side of the paper business card 910, not backside of the paper business card 910. Once the user puts a paper business card 910 inside the camera view 900, as shown in FIG. 44, the image of the paper business card 910 appears on the screen 400a. Then, the user presses a Capture icon 902. Thereby, the image of the paper business card 910 is captured in the cellular phone 200a. Before capturing, if the surrounding is dark and the image of the paper business card 910 is not legible enough, the user can tap a Dark icon 903. Thereby, the cellular phone 200a increases the exposure time of the camera. Therefore, the camera becomes more sensitive. When the user doesn't want to take the picture, he/she can press the Cancel icon 556. Then, the display image turns back to FIG. 34.

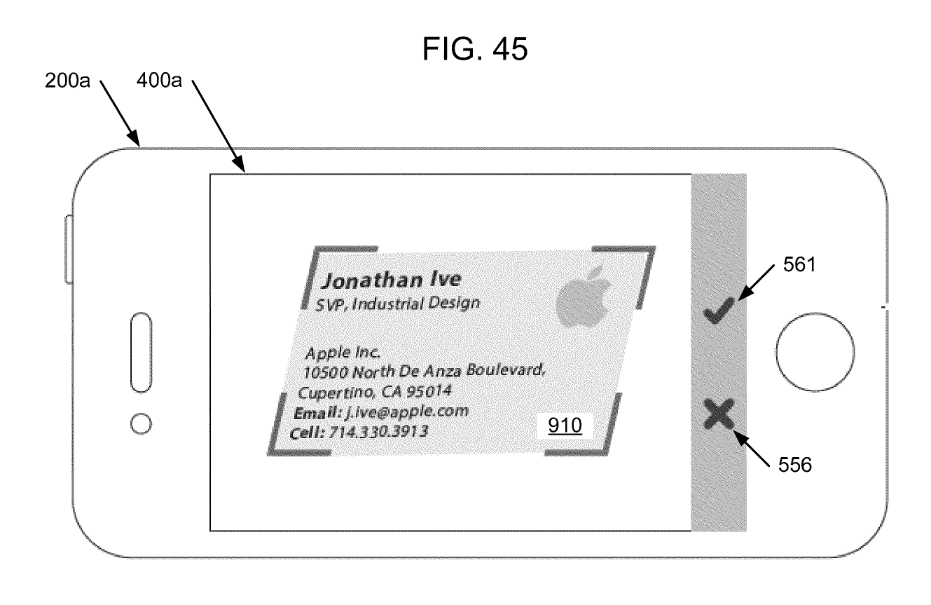

Once the image of the paper business card 910 is captured, the display image turns like FIG. 45. As shown in this figure, the captured image of the paper business card 910 is displayed on the screen 400a. Then, the user taps the Confirm icon 561 to make the cellular phone 200a store the captured image. When the Cancel icon 556 is pressed, the display image turns back to FIG. 44 and the user can retake the picture of the paper business card 910.

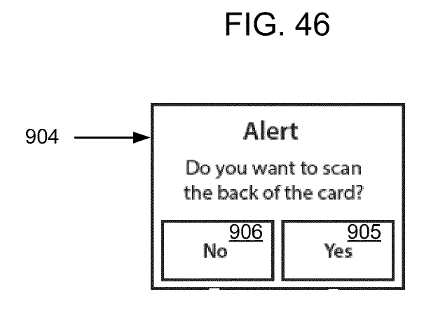

Once the user confirms the captured picture of the front side of the paper business card 910, the display image turns like FIG. 46. A message 904 appears in the center portion of the screen 400a. The message 904 asks if the user wants to scan the backside of the paper business card 910. If the user taps the ‘Yes’ icon 905, he/she can scan the backside of the paper business card 910 with the same procedure of scanning the front side of the paper business card 910. If the user taps the ‘No’ icon 906, the scan of the backside of the paper business card 910 is skipped. Actually, the display image of FIG. 46 is shown only when the setting item “Enable Card Backs By Default” 813 is OFF (please refer FIG. 36). When the setting item “Enable Card Backs By Default” 813 is ON, the electronic business card application software prompts the user to scan the backside of the paper business card 910 without showing the message 904.

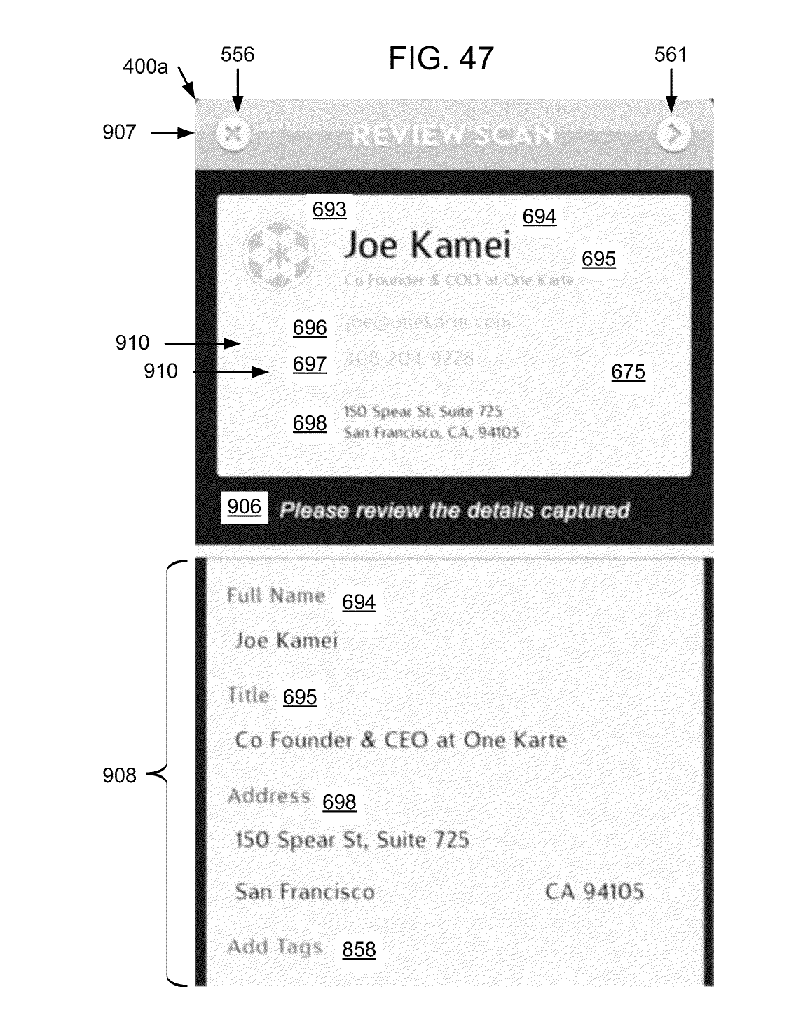

Once the scanning of the paper business card 910 is done, the display image turns like FIG. 47. As shown in this figure, a ‘REVIEW SCAN’ tab 907 is displayed in the upper part of the screen 400a. Below this tab 907, the image of the scanned electronic business card 910 is displayed. Below this image 910, a message 906 is displayed. This message 906 prompts the user to check if the text information extracted from the paper business card 910, such as person's name 694, company name and title 695, e-mail address 696, telephone number 697 and address 698, is correct. The extracted and categorized information is displayed in the text fields 908.

One convenient feature of the electronic business card application software is that it automatically extracts the information 694-698 printed in the paper business card 910 as a text information. The software integrates an OCR (Optical Character Recognition) software. Once the scan of the paper business card 910 is done, the software calls the OCR software and extracts the text information. Then, the software automatically categorizes the extracted text information. In other words, the software automatically recognizes and extracts the information about the person's name 694, the company name and title 695, the e-mail address 696, the telephone number 697 and the address 698. Then, the software displays the extracted and categorized text information in the text fields 908. When the probability that the extracted text information is correct is not expected to be high, in other words, below a threshold level, such text information is highlighted in the text fields 908 (not depicted in the figure) to draw user's attention. In FIG. 24, by the ‘Edit Info’ icon 683, a numeral 909 is indicated. When this numeral 909 appears, there is at least one field in which the software is not confident about the accuracy of the extracted text information. The numeral 909 prompts the user to check if the information in the field is correct.

Going back to FIG. 47, when the user taps one of the text fields 908, the display image turns like FIG. 48. In the upper part of the screen 400a, an ‘EDIT INFORMATION’ tab 911 is displayed. Below the tab 911, the text fields 908 are displayed. There, the user can edit the text information, using the on-screen keyboard 530. The user can also add a keyword by tapping an Add Keyword icon 858. This procedure is same as the one explained with FIG. 23.

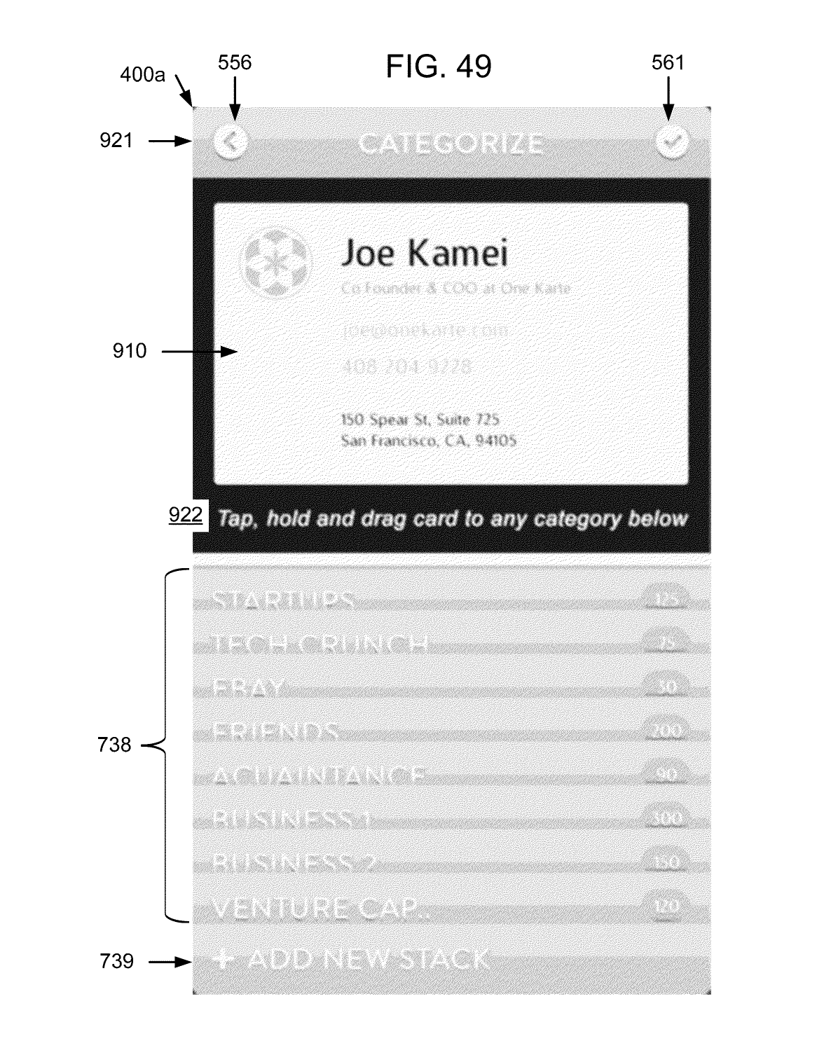

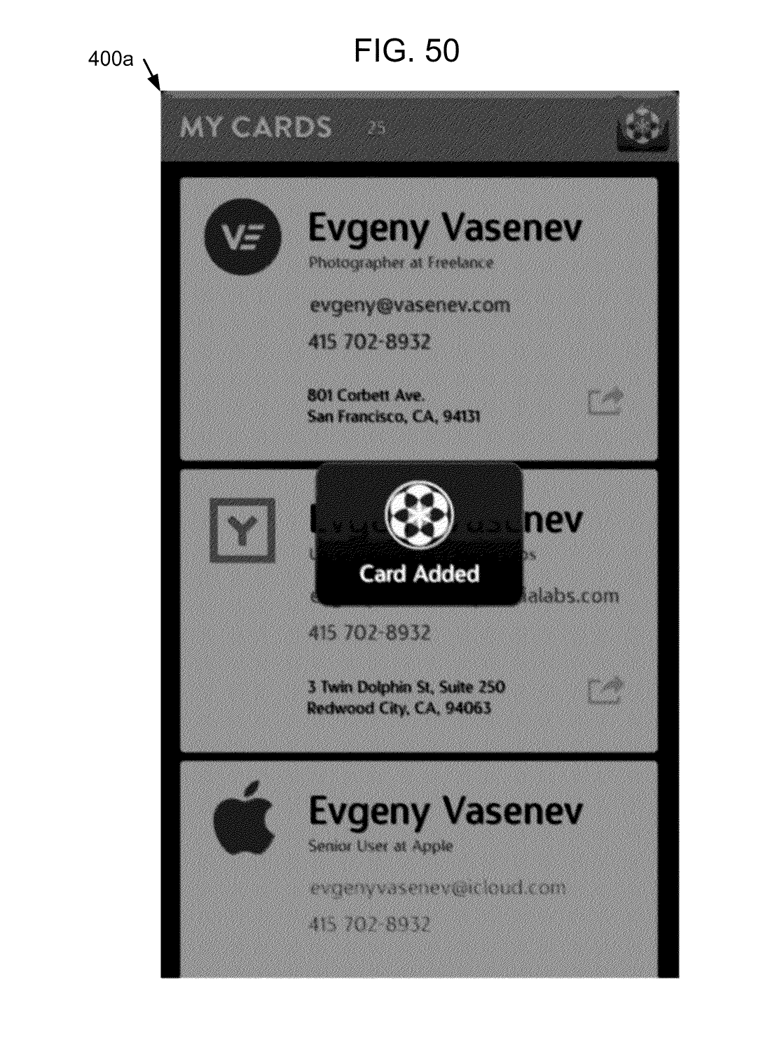

Going back to FIG. 47, when the user finishes the editing of the text information, he/she taps the Proceed icon 561. The user can also go back the display image of FIG. 45 by tapping the Back icon 556. Once the user proceeds, the display image turns like FIG. 49. As shown in this figure, a ‘CATEGORIZE’ tab 921 is displayed in the upper part of the screen 400a. Below this tab 921, the image of the scanned paper business card 910 remains to be displayed. Below this image 910, a message 922 is displayed. This message 922 prompts the user to categorize the scanned paper business card 910. Below this message 922, categories 738 are displayed. The user drags and drops the scanned paper business card 910 into one of the categories 738. Thereby, the scanned paper business card 910 is categorized in the category the user wants to categorize in, and as shown in FIG. 50, the scan of the paper business card 910 is done and the scanned paper business card 910 is stored as an electronic business card 910.

One unique feature of the electronic business card application software system is that once the scan of the paper business card 910 is finished, the electronic business card application software sends the saved text information of the paper business card 910 to the server 100 and the server 100 sends a text message to the person named in the paper business card 910 to encourage this person to become a user of the electronic business card application software.

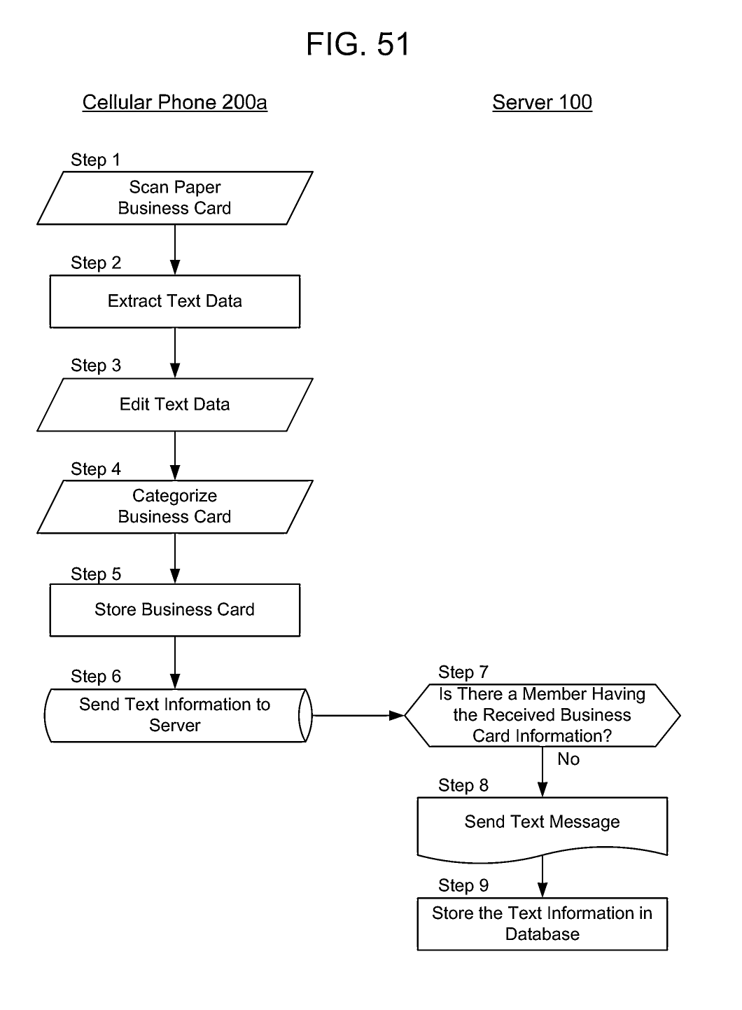

As shown in FIG. 51, first the user scans the paper business card 910 (Step 1 and FIGS. 44-46). Next, the electronic business card application software extracts the text information from the scanned paper business card 910 and categorizes the extracted text information (Step 2). Next, the electronic business card application software lets the user to review the extracted and categorized text information (Step 3 and FIGS. 47-48). Next, the electronic business card application software lets the user to categorize the scanned paper business card 910 (Step 4 and FIG. 49). Then, the cellular phone 200 stores the categorized paper business card 910 as an electronic business card (Step 5 and FIG. 50). Then, the electronic business card application software sends the categorized text information of this stored paper business card 910 to the server 100 (Step 6 and please refer FIG. 1). This text information can include the person's name 694, the company name and title 695, the e-mail address 696, the telephone number 697, and the address 698. Once the server 100 receives this text information, the server 100 checks if this person is already a member of the electronic business card application software and its service based on the text information sent from the cellular phone 200 (Step 7). If this person is not a member, the server sends a text message to a cellular phone having the telephone number 697 (Step 8). This text message recommends the reader to download the electronic business card application software and use the service provided by the electronic business card application software system. Furthermore, this text message contains a hyperlink so that the reader can download and install the electronic business card application software just by several clicks. Lastly, the server stores the received text information in its database 110 for the future use (Step 9).

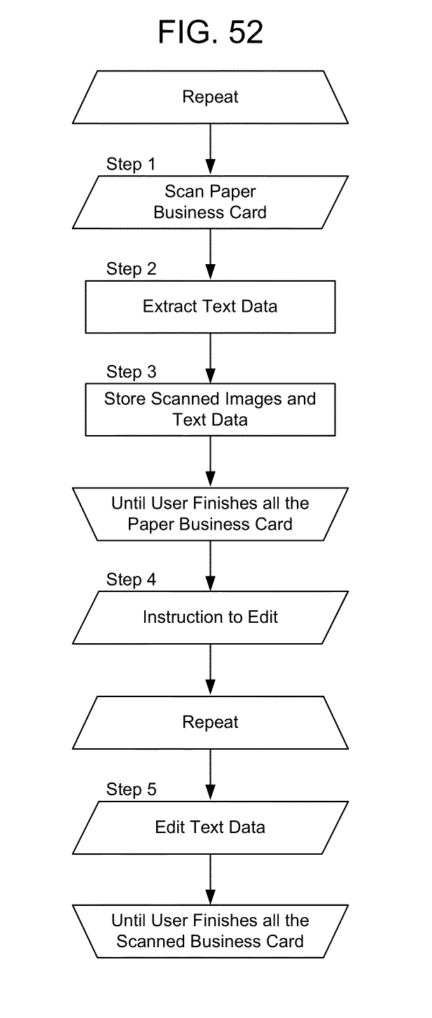

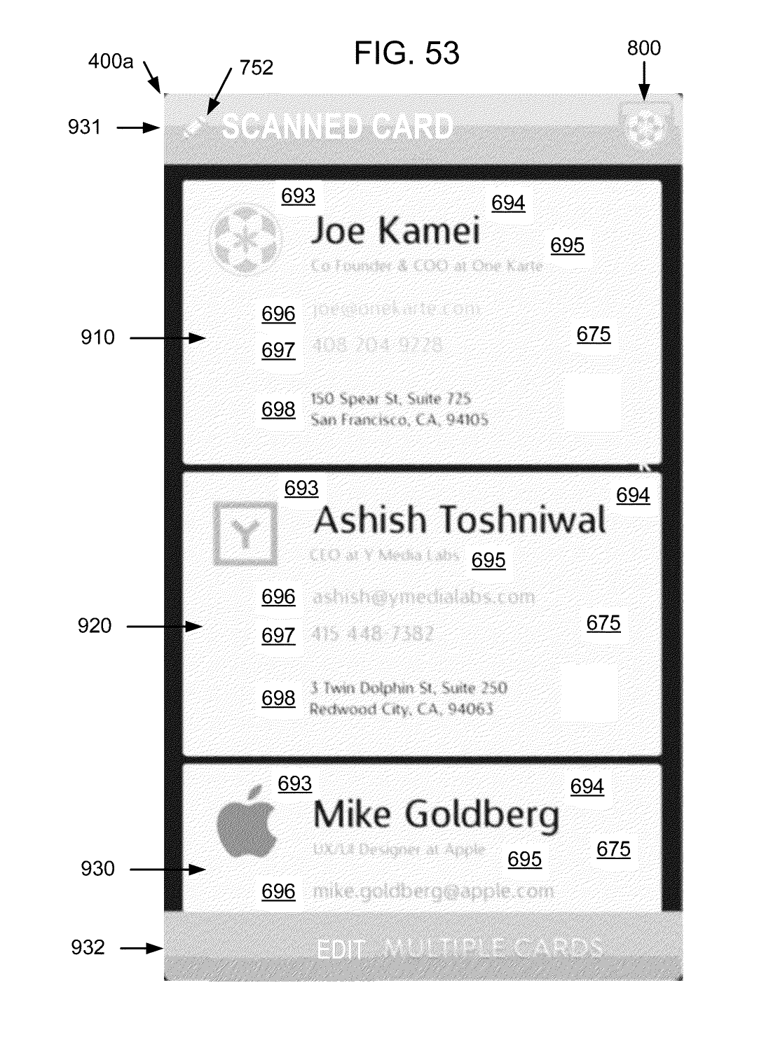

As shown in FIG. 34. There is a Multiple Scan icon 830, which is also visible as an item ‘SCAN MULTIPLE CARDS’ 760 in FIG. 20. If this Multiple Scan icon 830 is tapped, the electronic business card application software can scan plural paper business cards as a batch. As shown in FIG. 20, this function is also initiated by tapping an item ‘SCAN MULTIPLE CARDS’ 760. FIG. 52 shows a procedure to scan and process plural paper business cards as a batch. Once the user taps the Multiple Scan icon 830, the user takes a picture of a paper business card 910 in the same manner as explained with FIGS. 44-46 (Step 1). Then, the cellular phone 200a extracts text information from the scanned paper business cards and categorizes the extracted text information (Step 2). This Step 2 is done in the background. Then, the cellular phone 200a stores the image data of the paper business cards and the extracted and categorized text information (Step 3). The Steps 1-3 are repeated until the user instructs the electronic business card application software to finish scanning a paper business card. More exactly speaking, first the user takes a picture of the paper business card by tapping the Capture icon 902 (FIG. 44). Immediately, the software automatically extracts and categorizes the text information from the image data of the paper business card. Parallel to this, the user confirms the taken picture by tapping the Confirm icon 561 (FIG. 45). (Usually, the extraction and categorization are finished earlier than the user confirmation.) Then, the software stores the confirmed image and extracted and categorized text information in the cellular phone 200a. These steps are repeated until the user taps the Cancel icon 556. Thereby, plural paper business cards are scanned sequentially. As shown in FIG. 53, the scanned paper business cards 910-930 are categorized in a ‘SCANNED CARD’ category 931. Under this category 931, the scanned paper business cards 910-930 are aligned in a row in a same manner as electronic business cards. Although the user can edit each of the paper business cards 910-930 one by one as does for other electronic business card, he/she can also edit the paper business cards as a batch by tapping an item ‘EDIT MULTIPLE CARDS’ 932. Once the user initiates the ‘EDIT MULTIPLE CARDS’ 932 (Step 4), the user edits the extracted text information 694-698 and categorize the scanned paper business cards 910-930 in the same manner as explained with FIGS. 47-50 (Step 5). This Step 5 is repeated until the user finishes the edit and categorization of all the scanned paper business cards 910-930 or the user instructs the electronic business card application software to abort this step. Lastly, all the text information 694-698 confirmed by the user is sent to the server 100. Then, the text messages are sent to the people named in the paper business cards 910-930 to urge them to be a user of the electronic business card application software.

### §4.3 “Scout-All” Function

One characteristic feature of the electronic business card application software is that it can identify the people, who are currently located within certain distance from the user's current location, by one procedure. This function is called Scout-All. The difference of the Scout-All function from the Scout function explained before is that the Scout-All function enables the user to find all the contacts that are currently located within certain distance such as 500 meters from where the user is currently located while the Scout function enables the user to find where one specific person is currently located. To use the Scout-All function, the item “Make Location Public By Default” 814 shown in FIG. 36 must be turned ON. As shown in FIG. 34, there is a Scout-All icon 870. Once this Scout-All icon 870 is tapped, the Scout-All function is initiated.

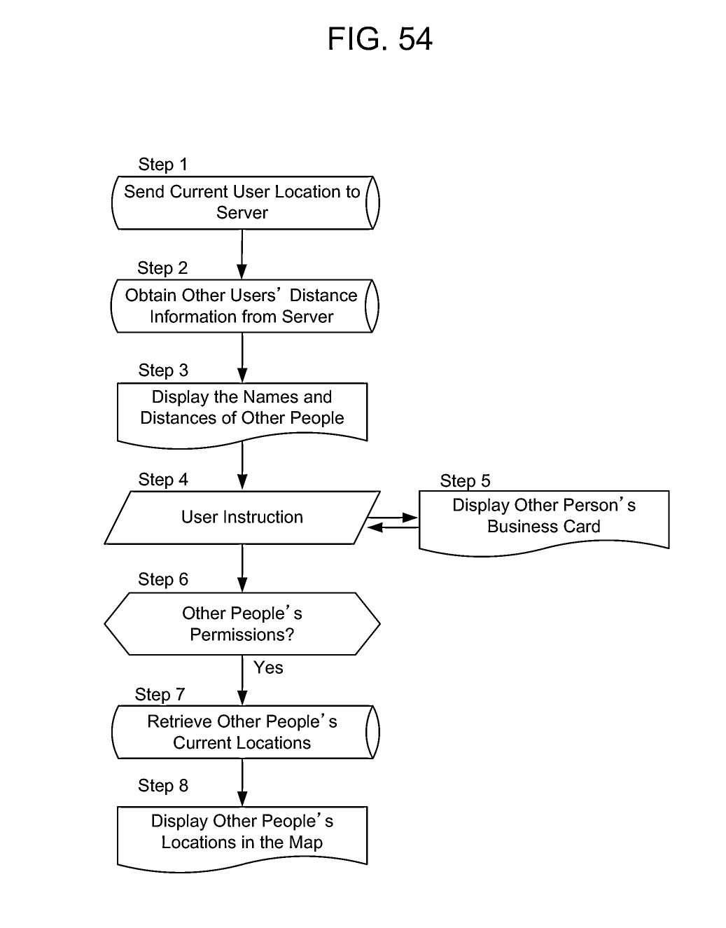

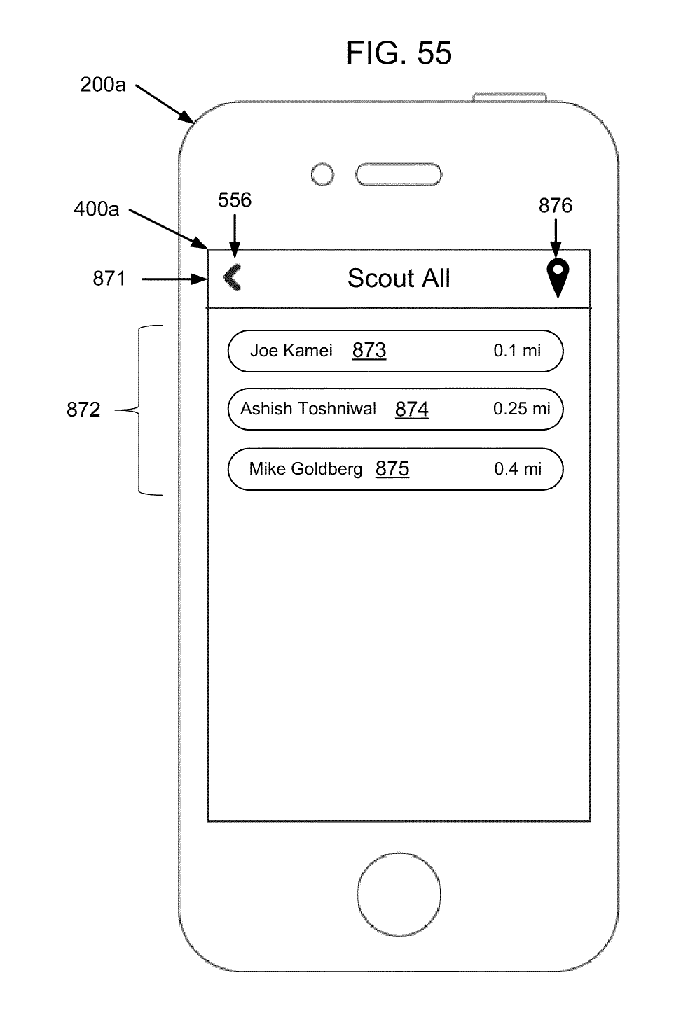

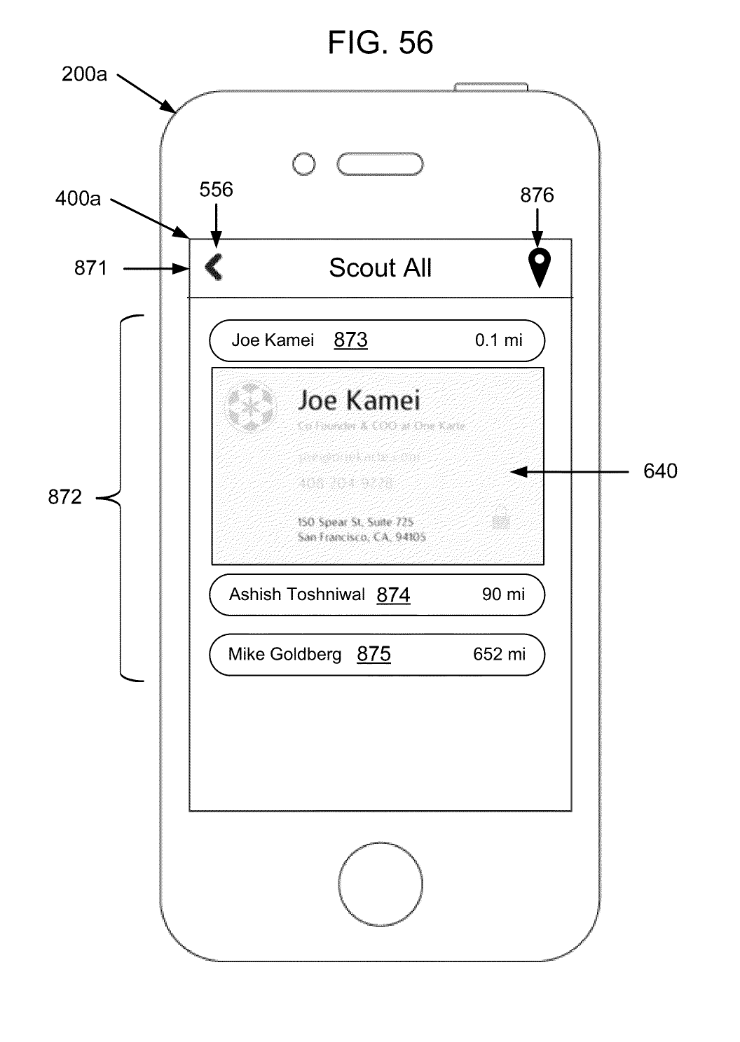

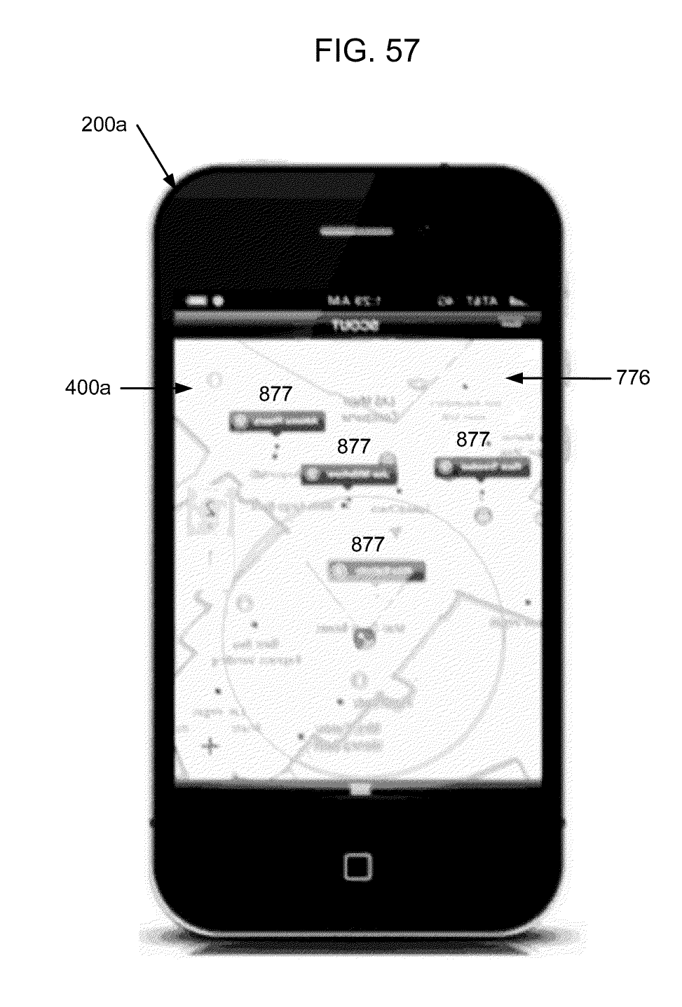

As shown in FIG. 54, the electronic business card application software first calls the internal GPS function of the cellular phone 200a and obtains the information where the cellular phone 200a is currently located. Then, the software sends this information to the server 100 (Step 1, please refer FIG. 1). Next, the software retrieves the other people's names and distance information, which are distances from the user's current locations to the other people's locations, from the server 100 (Step 2). This distance information is generated by the server 100 based on the location information sent from other users to the server 100. Once the cellular phone 200a receives the other people's distance information, the display image turns like FIG. 55 (Step 3). As shown in this figure, the ‘Scout All’ Tab 871 is displayed in the upper part of the screen 400a. Below this tab 871, a list 872 of other users' names and distances 873-875 from the user's current location is displayed. The order of the names is sorted based on the distances at a default setting. When the user taps one of the other users' names, for example the name 873 (Step 4), this person's electronic business card 640 is displayed below the name 873 as shown in FIG. 56 after other users' names 874-875 moves in the vertical direction and open a space for the electronic business card 640 (Step 5). The user can call the Scout function to this specific person named in the electronic business card 640. Alternatively, the user can tap a Map icon 876 shown in FIGS. 55 and 56. In this case, the permission requests are sent to all the users listed in the list 872 (Step 6). Then, the display image turns like FIG. 57. There, other users' locations 877, who have permitted to notify their current locations to the user, are indicated in a map 776 (Steps 7 and 8). The process to obtain the permission from other users is same as the one explained in the Scout function section. As long as the map software 776 is running, the software periodically updates the current user's location and other users' locations.

### §5. Data Synchronization of the Electronic Business Card Application Software System

Referring FIG. 1, one distinguished feature of the electronic business card application software is that it stores its data not only in the cellular phone 200a but also in the server 100. When the data in the cellular phone 200a is updated, this updated data is uploaded to the server 100. In addition, the electronic business card application software downloads and updates data in the cellular phone 200a when the data stored in the server 100 is newer. Furthermore, the software notifies the user when information of other person's electronic business card is updated. The software downloads this updated information based on user's permission.

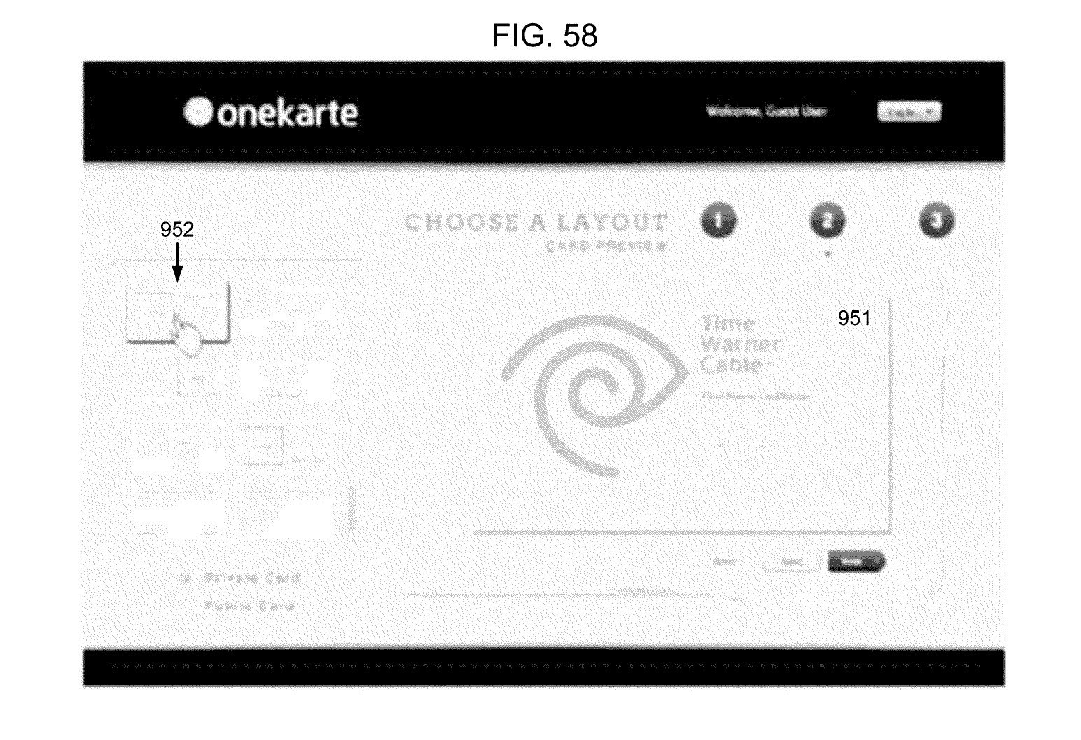

As shown in FIG. 58, the user can see the user's electronic business card 951, even using a computer 300a by accessing the server 100 through the Internet. Furthermore, the user can change the template 952 of user's electronic business card 951, and edit the information displayed on the electronic business card 951 through the computer 300a. Of course, the user can change some settings, including the property of the electronic business cards, of the electronic business card application software installed in the cellular phone 200a through the computer 300a. Such changes are detected by the cellular phone 200a. Once the user confirms, the software downloads the updates and reflects the changes in the cellular phone 200a.

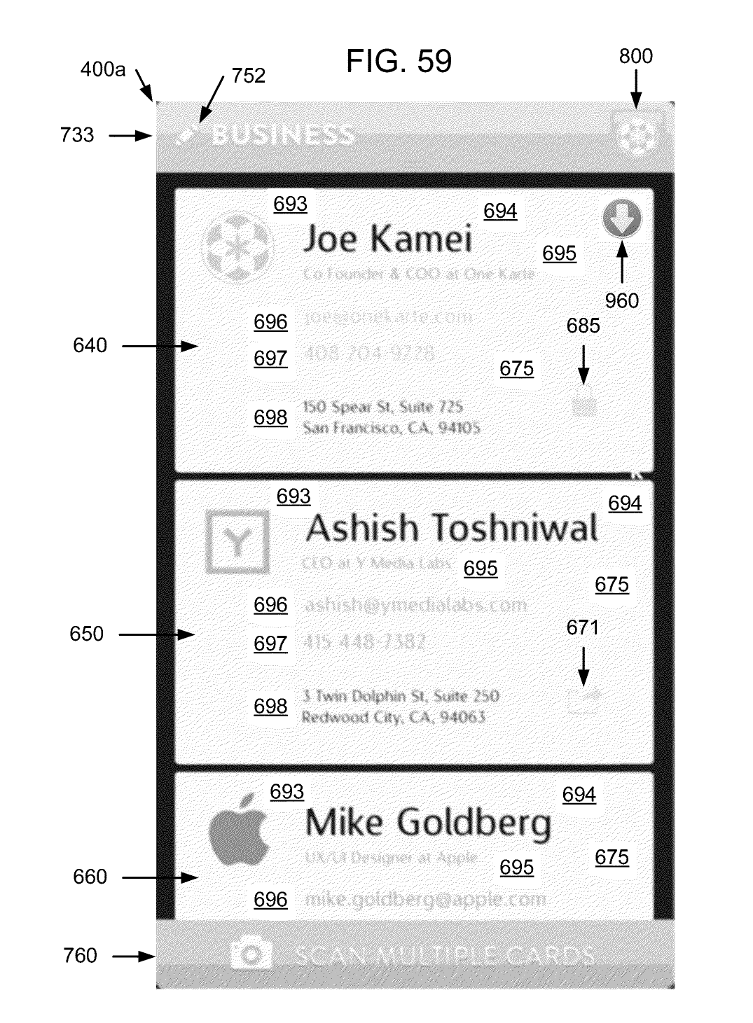

Besides, when other user has changed the content or property of his/her electronic business card, for example by operating the cellular phone 200b, this change is uploaded to the server 100. Then, the software downloads the changed content and updates the electronic business card about this other person in the cellular phone 200a upon user permission. For example, in FIG. 59, other people's electronic business cards 640-660 are shown in the screen 400a of user's cellular phone 200a, and one of other people's electronic business cards 640 is set as private. Thus, the Private icon 685 is displayed in the electronic business card 640, and the user cannot send this electronic business card 640 to a third person. When the other person operates the cellular phone 200b and changes, for example, the address as well as the property of his electronic business card 640 as Public (this change is achieved by a procedure explained with FIG. 36), this changed address and property is uploaded to the server 100 from the cellular phone 200b. Then, the cellular phone 200a detects this change. Then, as shown in FIG. 59, a Notification icon 960 is displayed on the electronic business card 640. This Notification icon 960 notifies the user that the data of electronic business card 640 is updated by the creator of this electronic business card. Once the user taps the Notification icon 960, the software displays a message asking if the user wants to update the data of electronic business card 640. If the user inputs Yes, the software downloads and updates the address and property of the electronic business card 640 as changed by the creator of the electronic business card 640. Because the property of the electronic business card 640 is changed as Public in this example, now the user can distribute the electronic business card 640 to a third person. The Notification icon 960 is also displayed in the screen of FIG. 34 when at least one of the electronic business cards is updated by its creator. Once the user taps this Notification icon 960, all the updates of the electronic business cards are performed as a batch process.

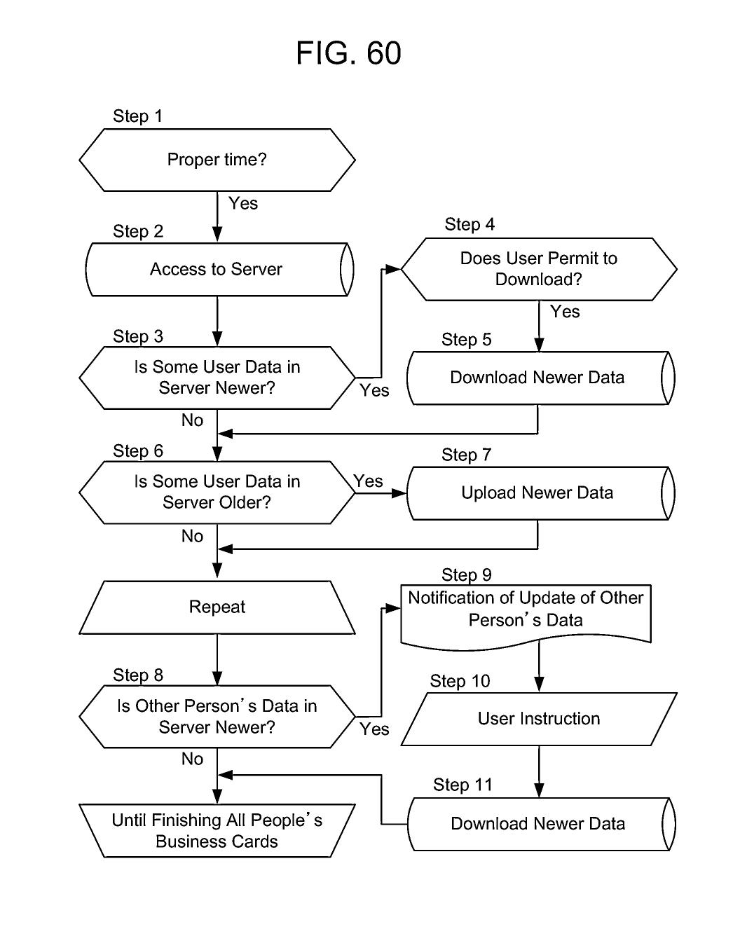

The above-explained process is achieved by the steps shown in FIG. 60. First, at a proper time of the day (Step 1), the cellular phone 200a accesses to the server 100 (Step 2). Examples of this proper time are the time when the CPU and network of the cellular phone 200a are not busy, or the time when the amounts of network and cellular phone usages generally become smaller such as late night to early morning. Then, the cellular phone 200a checks if there is a new or newer user data in the server 100a (Step 3). If there is, the cellular phone 200a notifies the user that there is an update about the user's data and asks the permission to update the internal data of the cellular phone 200a (Step 4). If the user inputs Yes, the cellular phone 200a downloads the newer data and updates its internal data (Step 5). This updated user data can include the property, layout and information of the user's electronic business card, other person's electronic business card received or scanned, category and keywords of other person's electronic business card that are set by the user, and a setting of the application software. The cellular phone 200a also checks if there is a missing or older user data in the server 100a (Step 6). If there is, the cellular phone 200a uploads the newer data stored in the cellular phone 200a to the server 100 and updates the data in the server 100 (Step 7). Lastly, the cellular phone 200a checks if there is an updated data about other person's electronic business card in the server 100a (Step 8) If there is, the cellular phone 200a displays a notification to inform the user that there is an update about the other person's electronic business card data (Step 9 and FIG. 59). Once the user instructs to update the other person's electronic business card data, the cellular phone 200a downloads the newer data from the server 100 and updates its internal data about this person's electronic business card (Steps 10 and 11). These Steps 8-11 are performed for all the other people's electronic business cards. Accordingly, for example, if the person of the electronic business card 640 shown in FIG. 59 has changed the company name and title 695, the e-mail address 696, the telephone number 697, or the address 698, the user can know this change without a big effort.

While the principles of the disclosure have been described above in connection with specific software and hardware, it is to be clearly understood that this description is made only by way of example and not as limitation on the scope of the invention.

TABLE 1

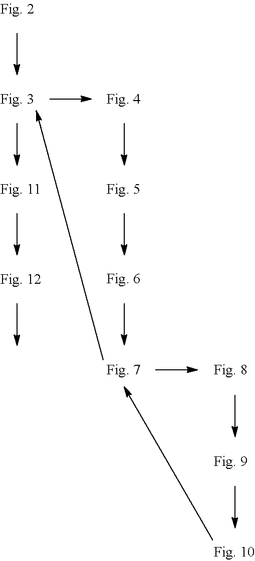

TABLE 2

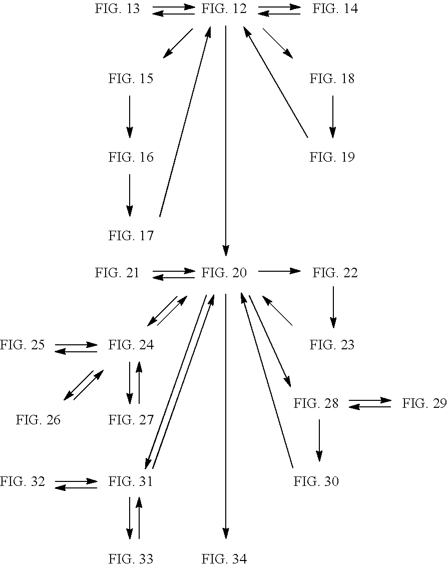

TABLE 3

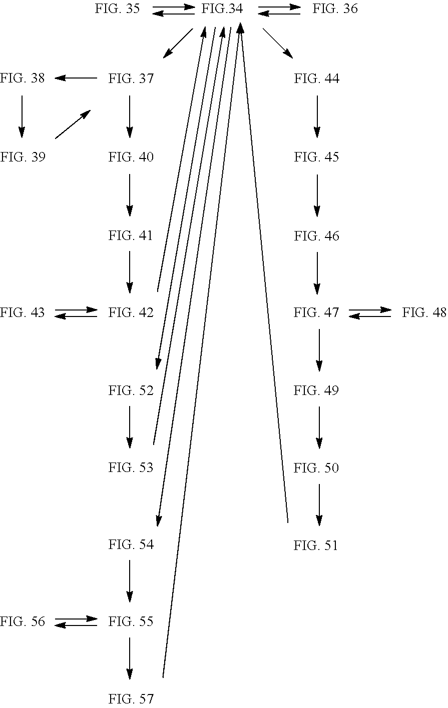

1. An electronic business card application software, which configures an electronic device to:
allow a user of the electronic device to set up an electronic business card in the electronic device;
display an icon representing an exchange of electronic business cards on a screen of the electronic device;
communicate with other electronic device placed close to said electronic device after said icon is selected;
send data of said electronic business card to the other electronic device; and
receive data of other person's electronic business card from the other electronic device.

2. The electronic business card application software of claim 1, which further configures the electronic device to:
display the received other person's electronic business card on the screen; and
allow the user to categorize the displayed electronic business card, wherein the categorization is achieved just by a drag-and-drop of the displayed electronic business card.

3. The electronic business card application software of claim 2, which further configures the electronic device to:
allow the user to create a new category just by selecting an icon representing a creation of new category.

4. The electronic business card application software of claim 2, which further configures the electronic device to:
display the other person's electronic business card on the screen so that the electronic business card occupies the majority of the screen when the screen orients in a landscape manner; and
display both the category name and the electronic business card on the screen when the screen orients in a portrait manner.

5. The electronic business card application software of claim 2, which further configures the electronic device to:
display an icon representing deletion of the electronic business card displayed on the screen when the user swipes a finger on the screen in a landscape direction of the electronic business card;
categorize the electronic business card as a trash when the user selects said icon;
allow the user to permanently delete only the electronic business card that is categorized as trash; and also allow the user to switch the category of the electronic business card from the trash to other category.

6. The electronic business card application software of claim 2, which further configures the electronic device to:
display candidates of keywords on the screen only by one tap of a finger on the electronic business card displayed on the screen;
allow the user to select a keyword about the displayed electronic business card; and
store the association of said electronic business card and the keyword.

7. The electronic business card application software of claim 6, which further configures the electronic device to:
display an icon representing an addition of a keyword while said candidates of keywords are displayed on the screen; and
allow the user to input a new keyword after said icon is selected.

8. The electronic business card application software of claim 7, which further configures the electronic device to:
provide a search to the user based on the keyword added by the user; and
seek electronic business cards said keyword is associated with, wherein the seek is performed over the whole categories.

9. The electronic business card application software of claim 1, which further configures the electronic device to:
allow the user to set a property of the user's electronic business card in a mode selected from the group consisting of an allowance mode and a disallowance mode;
wherein a recipient of the electronic business card is capable of distributing the received electronic business card to a third person when the received electronic business card is set as the allowance mode; and
wherein the recipient of the electronic business card is incapable of distributing the received electronic business card to a third person when the received electronic business card is set as the disallowance mode.

10. The electronic business card application software of claim 9, which further configures the electronic device to:
send the changed property information of the user's electronic business card to a server after the user has changed the property;
wherein the recipient's electronic device is configured to receive the changed property information from the server; and
wherein the property of the received electronic business card is changed based on the property information received from the server.

11. The electronic business card application software of claim 1, which further configures the electronic device to:
scan a paper business card;
display the image of the scanned business card on the screen;
extract text information from the scanned business card;
automatically categorize the extracted text information;
display the categorized text information at a certain location in the screen, wherein this location matches the category of the text information;
allow the user to check if the categorized text information is correct; and
store the categorized text information in the electronic device upon user's confirmation.

12. The electronic business card application software of claim 1, which further configures the electronic device to:
sequentially scan a plurality of paper business cards;
extract text information from the scanned business cards;
automatically categorize the extracted text information;
display an image of one of the scanned paper business cards in the screen;
display the categorized text information of said one of the scanned paper business cards at a certain location in the screen, wherein this location matches the category of the text information;
allow the user to check if the categorized text information is correct;
store the categorized text information in the electronic device upon user's confirmation; and
repeat displaying, allowing, and storing for the next scanned business card.

13. The electronic business card application software of claim 1, which further configures the electronic device to:
display a first icon representing to scan a plurality of paper business cards;
sequentially scan the plurality of paper business cards upon user's selection of the first icon;
extract text information from the scanned business cards;
automatically categorize the extracted text information;
display images of the scanned paper business cards in the screen so that the business cards are aligned in a row;
display a second icon representing to review the extracted text information of the scanned paper business cards as a batch work;
display an image of one of the scanned paper business cards in the screen;
display the categorized text information of said one of the scanned paper business cards at a certain location in the screen, wherein this location matches the category of the text information;
allow the user to check if the categorized text information is correct;
store the categorized text information in the electronic device upon user's confirmation; and
repeat displaying, allowing, and storing for the next scanned business card.

14. The electronic business card application software of claim 1, which further configures the electronic device to:
access to a server;
obtain current location information of other person, whose electronic business card is stored in the user's electronic device, from the server;
run a map software;
display a map on the screen; and
display the place, where said other person is currently located, in the map.

15. The electronic business card application software of claim 14, which further configures the electronic device to:
allow the user to set if the electronic device is permitted to send the information about the user's current location to said other person;
identify user's currently location; and
send the current user's location information to the other person's electronic device through the server only when the user has set the electronic device permitted to send the user's current location information to said other person.

16. The electronic business card application software of claim 1, which further configures the electronic device to:
store a plurality of other people's electronic business cards;
identify where the user is currently located;
obtain current location information of other people, whose electronic business cards are stored in the user's electronic device, from a server;
display names of the people who are currently located within a certain distance from the user's current location; and
also display the distances from where the user is currently located to where said people are currently located.

17. The electronic business card application software of claim 1, which further configures the electronic device to:
store a plurality of other people's electronic business cards;
display one of other people's electronic business cards on the screen, wherein this business card contains an indication of address;
allow the user to select the address;
run a map software based on the selection of the address;
send the address indicated in the displayed business card to the map software; and
display a direction from a place where the user is currently located to the address indicated in the displayed business card.

18. The electronic business card application software of claim 1, which further configures the electronic device to:
allow the user to set up a plurality of electronic business cards in the electronic device;
identify where the user is currently located;
automatically select one of the electronic business cards based on the current location; and
display the automatically selected electronic business card on the screen.

19. The electronic business card application software of claim 1, which further configures the electronic device to:
allow the user to set up a plurality of electronic business cards in the electronic device;
identify which country the user is currently located in;
display a message indicating that the user is currently in a country different from a country a primary electronic business card is designed to use in; and
also display a message asking the user if the user wants to change the electronic business card that is displayed on the screen at a first place.

20. The electronic business card application software of claim 1, which further configures the electronic device to:
allow the user to select a template of electronic business card while setting up the electronic business card, wherein the template contains information of a company;
prompt the user to input a passcode; and
enable the user to use said template for the user's electronic business card only when the inputted passcode is correct.

21. The electronic business card application software of claim 1, which further configures the electronic device to:
automatically upload the data selected from the group consisting of the user's electronic business card, the other person's electronic business card, categories defined by the user and a setting of the application software, to a server; and
download at least one of said data from the server upon user's permission when said at least one of the data stored in the server is newer than the one stored in the electronic device or when said at least one of the data is missing in the electronic device.

22. An electronic business card system, comprising
a server; and
an electronic business card application software installed in an electronic device;
wherein the electronic business card application software configures the electronic device to:
scan a paper business card;
extract text information from the image data of the scanned business card;
identify a telephone number from the extracted text information;
send the telephone number to the server; and
wherein the server sends a text message to the cellular phone having said telephone number, where said text message contains a message that recommends the reader to download the electronic business card application software.

23. The electronic business card system of claim 22, further comprising:
a database;
wherein the database stores the telephone number to which said text message is sent.
